(19) United States
(12) Patent Application Publication
(10) Pub. No.: US 2017/0102848 A1
(43) Pub. Date: Apr. 13, 2017

(54) MOBILE WEBSITE AUTHORING TOOL UTILIZING UNIQUE TILE LAYOUT CONVENTION FOR EASE OF NAVIGATION

(71) Applicant: SSKM CORPORATION, Athens (GR)

(72) Inventors: STAMATIOS SAMARAS, Athens (GR); KONSTANTINOS MAVROEIDIS, Athens (GR)

(21) Appl. No.: 14/489,711

(22) Filed: Sep. 18, 2014

(51) Int. Cl. G06F 3/0485; G06F 3/0484; G06K 7/10; G06K 19/06; H04L 29/08

(52) U.S. Cl. CPC G06F 3/0485; G06K 19/06037; H04L 67/02; G06K 7/10712; G06F 3/04842; G06F 2203/04803

(57) ABSTRACT

The present disclosure relates to an electronic system including a web page authoring environment configured to generate web pages comprised of scrollable tiles. In one scenario, the web pages are accessible by mobile devices by registered customers who have obtained access to a QR code which links the mobile device to the web page. Each viewable web page tile represents a different item of information which a content sourcer wishes to present to customers who obtain a QR code linking them via a mobile device to the web page. The authoring environment allows for editing the web page by selectively updating the content of existing tiles on the web page, deleting old tiles, and/or adding new tiles.

### RELATED APPLICATIONS

This application claims the benefit of U.S. Provisional Application No. 61/939,348, filed on Feb. 13, 2014, entitled “ELECTRONIC TILE LAYOUT FOR EFFICIENT SMALL SCREEN INTERFACE USER SELECTION” commonly owned and assigned to the same assignee hereof.

### FIELD

The present invention relates to website authoring tools, and particularly mobile website authoring tools and downloadable mobile applications.

### BACKGROUND

Mobile computing is becoming ubiquitous since the wide spread of public wireless networks and the popularity of portable computing devices. Nowadays, people can access the Internet wirelessly through many different portable devices such as notebooks, PDAs, and Smartphones. Wireless Access Points, known as “Hot Spots”, are available in most public spaces such as airports, hotels, hospitals, and shopping malls, to provide connectivity to the Internet at any time.

By using the built-in web browsers in the portable devices, users can browse web pages on the World Wide Web conveniently. However, since most web pages are originally designed for desktop computers, they do not fit well on the relatively small portable device screens. Users have to scroll the screen up and down and from left to right to locate the information they want. The situation becomes much more difficult if the web pages contain multiple frames.

Users typically have different browsing preferences. Some of them do not want to show animations, and some do not want to play sound; others might not want to receive any images at all. The difficulty of predicting the behavior patterns and wants of users leads into another problem with web content delivery.

To address this problem, a variety of authoring protocols and tools have been designed that either help mobile site owners better design sites that are intented to be viewed on small screens.

The prevalence of smartphones and other similar devices also brought about new clever ways by which advertisers, marketers, news sites, bloggers, merchants, brand owners, movie theaters, and others try to feed and promote both commercial and non-commercial content to customers and potential customers.

One example of a clever medium to quickly connect a promoter to a promotee are bar codes, and particularly, QR codes. QR codes have also become ubiquitous as they provide a quick and easy way for folks to electronically scan a QR code and instantly extract linking information embedded therein. QR code reader applications available on Android and iPhone app stores, usually for free, make it possible for any smartphone to scan a QR code, interpret the linking information and then typically launch a browser that will take the smartphone subscriber to a linked-to site. Some QR codes initiate calls to servers which cause an event to happen, such as a request for an application download. The application could be a game, a business application, an electronic platform interface tool, or any other application capable of being downloaded and executed on the smartphone.

There is always a need for tools that are capable of expanding the user friendliness and power of QR codes and at the same time take advantage of the ubiquitous nature of smart phones today. There is a further need for content deliverers and aggregators to be able to provide effective new ways to deliver content which at same time enrich the experience of users of smartphone and tablet owners seeking and/or receiving that content.

### SUMMARY

The present disclosure relates to an electronic system including a web page authoring environment configured to generate web pages comprised of scrollable tiles. In one scenario, the web pages are accessible by mobile devices by registered customers who have obtained access to a QR code which links the mobile device to the web page. Each viewable web page tile represents a different item of information which a content sourcer wishes to present to customers who obtain a QR code linking them via a mobile device to the web page. The authoring environment allows for editing the web page by selectively updating the content of existing tiles on the web page, deleting old tiles, and/or adding new tiles.

On the mobile device side, a resident software program enables the retrieving and displaying of a web page defined by a set of scrollable tiles. The set of scrollable tiles are of the type generated by a content sourcer using a software product configured as a web page authoring tool with specific rules to facilitate tile creation. The mobile device is configured to (i) scan a QR code associated with the web page; (ii) place a request to a server to feedback the web page; (iii) display the web page; and (iv) enable a scrolling tile feature to facilitate quick viewing of the tiles.

On the mobile device side, a server supported mobile application identifies individuals, establishes location and language preferences, and ultimately produces content to mobile device customers/members in a customized way that improves overall user experience.

The present approach is unique also in that it enables the distribution of coupons by merchants to consumers. In one scenario, such coupons cannot be consumed by the same person more than once, and/or can only be consumed in a predefined geographical area.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 is a high level block diagram of an exemplary electronic system configured to create (and serve up) mobile sites to portable wireless devices, where each mobile site is comprised of selectively generated tiles in accordance with an exemplary embodiment

FIG. 2 shows the response that users receive on their mobile devices after scanning a registered sign registered with the MALLFOX service (QR, Barcode, shape or other), or a non-registered barcode, or QR sign.

FIG. 3 shows the composition of each response containing a variable number tiles, a background image as minimum elements.

FIGS. 4 and 5 show how mobile users can scroll the contents up and down when these contents are too big to fit in the screen.

FIG. 6 shows how mobile users can tap on each tile to quickly access more information, and then return to the main screen with the initial tileset.

FIG. 7 shows how mobile users can access video and mobile web pages by tapping on tiles.

FIG. 8 illustrates the collection feature; when users scan something, the tileset which is generated in response, is kept in the user's collection.

FIG. 9 shows how the information in the user's collection remains updated and contents displayed contain what the MALLFOX subscriber company has prepared up to that point.

FIG. 10 shows the ability of each user to share the content of their scans by tapping on the envelop icon, and adding a personalized message.

FIG. 11 shows the start enrollment of the user. A password is generated as to make enrollment easier by the mobile device.

FIG. 12 shows the screen which mobile users use to provide their credentials and access their account.

FIG. 13 shows the screen where consumers and content creators can provide their credentials and access their account. The system identifies users and directs them to other pages where they can use the system.

FIG. 14 shows the interface where users can update their personal information and their preferences.

FIG. 15 shows how consumers can access the content of items they have scanned using a traditional desktop or mobile browser.

FIGS. 16, 18 19 and 20 show the MALLFOX mobile application after a user has successfully logged in, with four icons at the bottom of the mobile screen, allowing users to access and change their preferences, view their collection, add a photo to their collection and access the newsletter feature of the application.

FIG. 17 shows the basic options offered to mobile consumers, which are to scan bar codes using the front or the rear camera of the device provided that the mobile device has these hardware options, light up the flash of the front camera of the device, log out of the device and access other preferences.

FIG. 21 shows the newsstand option of the mobile application, where users can find a personalized collection of news that come from QRs that mobile users chose to keep in their collection.

FIG. 22 shows how the mobile device application looks when a QR code has been placed in front of it right before the personalized tileset is downloaded and displayed.

FIG. 23 shows the rendered personalized tileset which exceeds the size of the screen and can be viewed when the users scrolls up and down the screen.

FIGS. 24 and 25 show the result of mobile users tapping on a tile, there being an expanded screen displayed with the relevant personalized information.

FIGS. 26-30 and 31 show how a user can choose to make a personal note related to this tileset, forward this tileset to another person, send a message to the creator-company, or close the tileset.

FIGS. 32-37 show how the users of the MALLFOX mobile app can access their personalized collection of MALLFOX scans and photos, viewing the updated information and filtering the results.

FIG. 38 shows the private web page which MALLFOX content creators can access and view all messages that have been sent to them by consumers.

FIG. 39 shows the private web page where MALLFOX content creators can access and view the businesses for which they can create tilesets and access more detailed relevant information.

FIGS. 40-41 show the private web page where MALLFOX content creators can access and view the MALLFOX QR codes which have been generated on the platform for a particular business.

FIGS. 42-52 show the private web pages where MALLFOX content creators can access and edit the properties of a single QR code, as well view and edit the tiles linked to that QR, enabling the customized experience for mobile users.

FIG. 53 shows the private web page where MALLFOX content creators can access and view a report on how many mobile users scanned their content and in which locations, with various options to filter and export this information.

FIGS. 54 and 55 show the private web pages where MALLFOX content creators can access and edit contests linked to special tiles in their tileset.

FIGS. 56 and 57 show the private web page where MALLFOX content creators can access and view their issued coupons and issue new ones.

FIGS. 58-61 show the private web page where MALLFOX content creators can access and view their consumer clubs. This page allows content creators to start a club, and view how many members have joined, and what they have consumed.

FIG. 62 shows how a consumer club appears inside the MALLFOX mobile app after it has been linked to a QR of a bar-code driven tileset.

FIGS. 63 and 64 shows the sending of messages and particularly how a business can add a promotional message which will be sent by e-mail to all mobile users who have chosen to keep this business in their collection.

FIG. 65 shows how businesses can use the same exact tileset for a number of different bar code signs, for example all of the bar codes issued to each product in a product category.

FIG. 66 shows how a business can limit access to a tileset for only registered users in the MALLFOX app, who have specific usernames.

FIG. 67 is a high level operational flow diagram showing the routine for creating a MALLFOX web page in accordance with an exemplary embodiment.

FIG. 68 is a high level operational flow diagram showing the routine for retrieving and displaying a MALLFOX web page in accordance with an exemplary embodiment. If the page is accessed from a generic QR scanner and displayed in a browser it will not be personalized, nor will it enable the consumption of coupons, participation in clubs and contests.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The following description is intended to convey a thorough understanding of the embodiments described by providing a number of specific embodiments and details involving methods and systems for managing content submission and publication of content. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The description below provides a discussion of servers, computers, and other devices that may include one or more modules. As used herein, the term “module” may be understood to refer to software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the described particular module. Further, the modules may be implemented across multiple devices and/or other components local or remote to one another. Additionally, the modules may be moved from one device and added to another device, and/or may be included in both devices. Any software implementations of the present invention may be tangibly embodied in one or more storage media, such as, for example, a memory device, a floppy disk, a compact disk (CD), a digital versatile disk (DVD), or other devices that may store computer code.

The terminology used herein is for the purpose of describing particular embodiments only and is not intended to limit the scope of the present invention. As used throughout this disclosure, the singular forms “a,” “an,” and “the” include plural reference unless the context clearly dictates otherwise. Thus, for example, a reference to “a module” includes a plurality of such modules, as well as a single module, and equivalents thereof known to those skilled in the art.

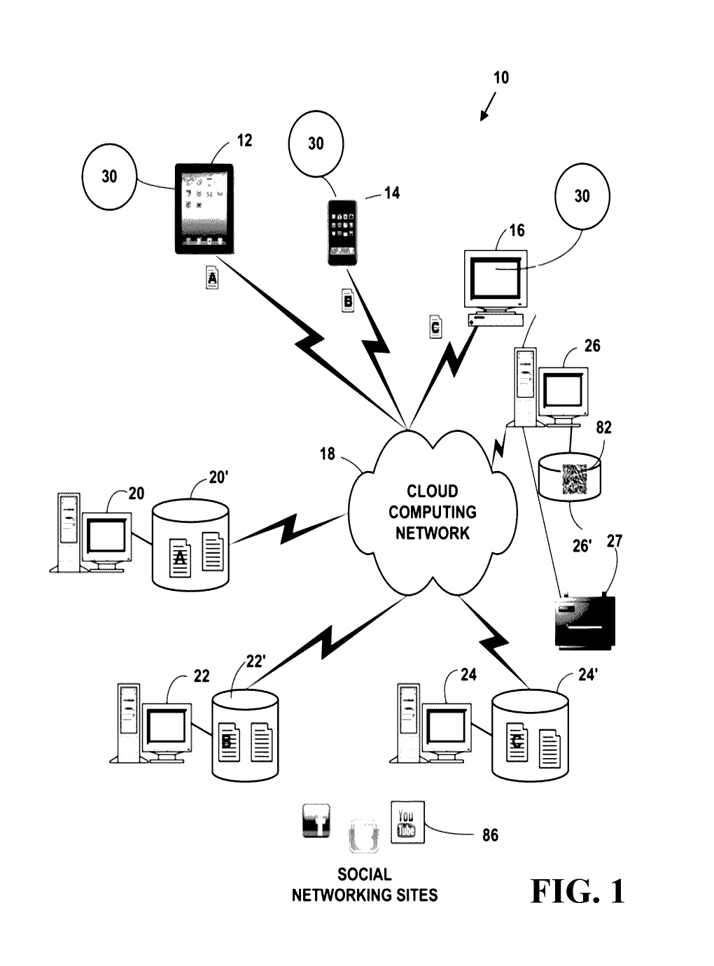

FIG. 1 is a high level block diagram of an exemplary electronic system configured to create (and serve up) mobile sites to portable wireless devices, where each mobile site is comprised of selectively generated tiles in accordance with an exemplary embodiment.

The exemplary electronic system 10 includes, but is not limited to, one or more target network devices 12, 14, 16 (only three of which are illustrated) each with one or more processors and a computer readable medium.

The one or more target network devices 12, 14, 16 include, but are not limited to, multimedia capable desktop and laptop computers, tablet computers, facsimile machines, mobile phones, non-mobile phones, smart phones, Internet phones, Internet appliances, personal digital/data assistants (PDA), two-way pagers, digital cameras, portable game consoles (Play Station Portable by Sony, Game Boy by Sony, Nintendo DSI, etc.), non-portable game consoles (Xbox by Microsoft, Play Station by Sony, Wii by Nintendo, etc.), cable television (CATV) set-top boxes, digital televisions including high definition television (HDTV), three-dimensional (3D) televisions and other types of network devices.

The one or more smart network devices 12, 14, 16 also include smart phones such as the iPhone by Apple, Inc., Blackberry Storm and other Blackberry models by Research In Motion, Inc. (RIM), Droid by Motorola, Inc. HTC, Inc. other types of smart phones, etc. However, the present invention is not limited to such smart phone devices, and more, fewer or other devices can be used to practice the invention.

A “smart phone” is a mobile phone that offers more advanced computing ability and connectivity than a contemporary basic feature phone. Smart phones and feature phones may be thought of as handheld computers integrated with a mobile telephone, but while most feature phones are able to run applications based on platforms such as Java ME, a smart phone usually allows the user to install and run more advanced applications. Smart phones and/or tablet computers run complete operating system software providing a platform for application developers.

The operating systems include the iPhone OS, Android, Windows, etc. iPhone OS is a proprietary operating system for the Apple iPhone. Android is an open source operating system platform backed by Google, along with major hardware and software developers (such as Intel, HTC, ARM, Motorola and Samsung, etc.), that form the Open Handset Alliance.

The one or more smart network devices 12, 14, 16 also include tablet computers such as the iPad, by Apple, Inc., the HP Tablet, by Hewlett Packard, Inc., the Playbook, by RIM, Inc., the Tablet, by Sony, Inc.

The target network devices 12, 14, 16 are in communications with a cloud communications network 18 via one or more wired and/or wireless communications interfaces. The cloud communications network 18 includes, but is not limited to, communications over a wire connected to the target network devices, wireless communications, and other types of communications using one or more communications and/or networking protocols. In one embodiment, the cloud communications network 18 also includes a cloud communications network 19.

Plural server network devices 20, 22, 24, 26 (only four of which are illustrated) each with one or more processors and a computer readable medium include one or more associated databases 20′, 22′, 24′, 26′. The plural network devices 20, 22, 24, 26 are in communications with the one or more target devices 12, 14, 16 via the cloud communications network 18.

The plural server network devices 20, 22, 24 26, include, but are not limited to, World Wide Web servers, Internet servers, search engine servers, vertical search engine servers, social networking site servers, file servers, other types of electronic information servers, and other types of server network devices (e.g., edge servers, firewalls, routers, gateways, etc.).

The plural server network devices 20, 22, 24, 26 also include, but are not limited to, network servers used for cloud computing providers, etc. The plural server network devices 20, 22, 24, 26 include one or more printing devices 27 (only one of which is illustrated) each including one or more processors.

The cloud communications network 18 includes, but is not limited to, a wired and/or wireless communications network comprising: the Internet, an intranet, a Local Area Network (LAN), a LAN (WiLAN), a Wide Area Network (WAN), a Metropolitan Area Network (MAN), a Public Switched Telephone Network (PSTN), a cloud communications network 26 and other types of wired and/or wireless communications networks 18.

The cloud communications network 18 may include one or more gateways, routers, bridges and/or switches As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments based on some pre-determined sequence (e.g., timing, sequence number, etc.).

An operating environment for the network devices of the exemplary electronic information display system 10 include a processing system with one or more high speed Central Processing Unit(s) (CPU), processors, one or more memories and/or other types of computer readable mediums. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical information by the CPU or processor. An electrical system represents data bits which cause a resulting transformation or reduction of the electrical information or biological information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

The example electronic system—described below in greater detail—is a clever online platform server service and mobile website authoring environment and a mobile application—packaged under the trade name MALLFOX™.

The mobile website authoring environment enables content sourcers—e.g., content deliverers, content aggregators, merchants, advertisers, product and/or service promoters, and others interested in having folks go to a site to obtain information—to be able to easily and quickly build a unique type of site, This site (once created) is assigned to a QR code (or linked to a QR code if one already is available). Unlike traditional uses and applications of QR codes which normally take the user to single link (via a local browser), the intent here is that each QR code branches into a customizable, powerful direct marketing tool the aim of which is to minimizes the distance between advertisers and brands (content sourcers) and each of their customers.

This is achieved by pointing each QR code to a single page stored on the MALLFOX servers. Each page is defined by a plurality of tiles laid out in a unique and user friendly manner,

Each tile is itself intended to serve as a link to specific advertising and/or non-commercial content which the website creator wishes to pass on to a customer.

The customer is by definition someone who identified a QR code of interest in a magazine, a book, on the web, on a monitor, a billboard, or any other conceivable means and who has scanned that QR code with the intent of acquiring or being fed information from a content sourcer.

The content sourcer is the person who created the site that prospective customers will be taken to; and which once there, will be shown a plurality of tiles, preferably links to additional information of more specific interest or nature.

Each tile can be a link to other web sites, social media, advertisements, contest and coupons, reference material (PDFs and/or instruction manuals), new audio, video, or audiovideo media, including movies, MP3s, MP4s, and other similar material of interest.

For marketers and brand owners, each Mallfox page is sort of a like a QR code accessible Facebook™ page. Except rather than type in a website address (though this too is possible), customers and brand followers, scan a a QR code that they come across.

Just like with any proprietary website page, marketers and brand owners can take advantage of powerful analytics tools, location relevant targeted advertising, and locality specific information to serve language appropriate content, as well as culturally sensitive and politically correct content, to customers and brand followers.

Customer behavior is collected automatically, instantly, and globally; and it can be used to forecast current and future needs and trends.

As will be shown in exampled below, tiles can be used to introduce customers to contests as well as offer promotional coupons and incentives.

In addition, customers can be uniquely targeted to take part in marketing, advertising, promotional, survey, and the like, on a geographic or regional basis. A local wine tasting event promotion is one such example.

The unique aspect of MALLFOX however is not the tiled websites, but the tiles themselves, and the accompanying suite of authoring tools that are made available to content sourcers to be able to easily and quickly construct a tiled page.

Why tiles? Tiles are a clever and unique way to communicate information because of the ease by which they can take advantage of the touch screen nature of small screen devices. Just like pictures in a picture book of a smartphone, capable of allowing a viewer to quickly scan through dozens, hundreds, and in some cases thousands of pictures on the phone, the same concept is employed by MALLFOX to build MALLFOX renderable websites.

The tile concept allows the platform authoring environment in size and space (but not content variability). By making the authoring environment simple to learn and use (but not limited in terms of content variability), site creators don't have to feel overwhelmed in setting out to build a site.

In a preferred scenario, the format is WYSWYG, which means it is easy to learn and use. Because the range of rules associated with building tiles are few and limited, more and more brand owners are likely to want to promote themselves via MALLFOX sites, using dedicated QR Codes, which they can promote as MALLFOX QR codes displayed anywhere QC codes are displayed.

The tiled interface proposed herein is unique and environmentally friendly. This is because supermarket chains, for example, can do away with circulars and flyers, and instead launch electronic MALLFOX smartphone viewable pages with hundreds of equally relevant tiles of pictures representing the promotions in traditional same circulars and flyers. With MALLFOX circulars, however, the experience for the customer is even more enriching as he or she can—when for example the picture of a promotional item on sale is a link—click on that link to find out specific information about the product (calories, competing or generic store products and pricing, and other information that is normally not available on hard paper sources).

The present approach essentially eliminates paper promotions going forward and replaces them with QR codes distributed to smartphone users in various venues and forums.

The digital media companies responsible for hard print will instead deal with MALLFOX site creation, which as proposed herein, is a trivial, easy, and quick feature selection and deselection process, followed by some limited knowledge of uploading and linking tiles to files, photos, videos, text documents, other websites, etc.

MALLFOX is a unique way for marketers and promoters to connect with their customers in a unique and interactive way. MALLFOX enables companies to turn traditional marketing departments into MALLFOX pages linked to QR codes. Customers will have instant access to news, promotions, coupons, specials, promotions in general, but also access to new and fresh information about their favorite sports teams, store brands, shops, virtually 24-7.

In one exemplary embodiment, access to MALLFOX content sites requires visitors to register as well. This creates a social community of sorts, and over time, draws more and more visitors from other social media sites where advertising and promotional material is served based on what robots think the member is likely interested in seeing, rather than what he/she has proactively sought to follow.

More detailed aspects of the present invention will now be described with reference to the following figures and drawings.

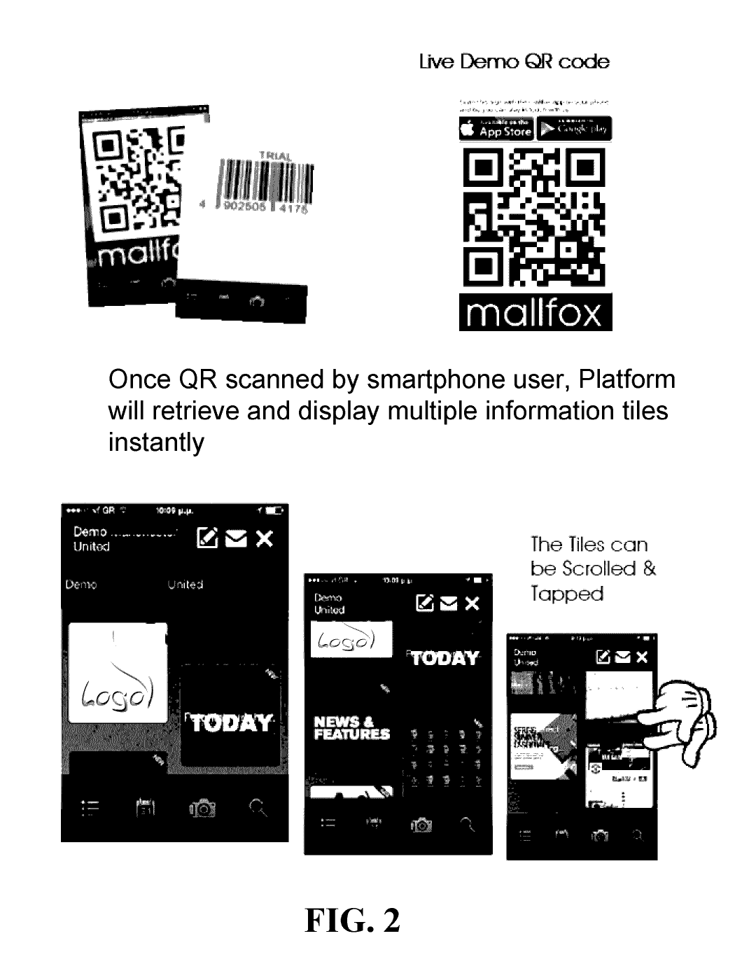

FIG. 2 shows the response that users receive on their mobile devices after scanning a registered sign registered with the MALLFOX service (QR, Barcode, shape or other), or a non-registered barcode, or QR sign.

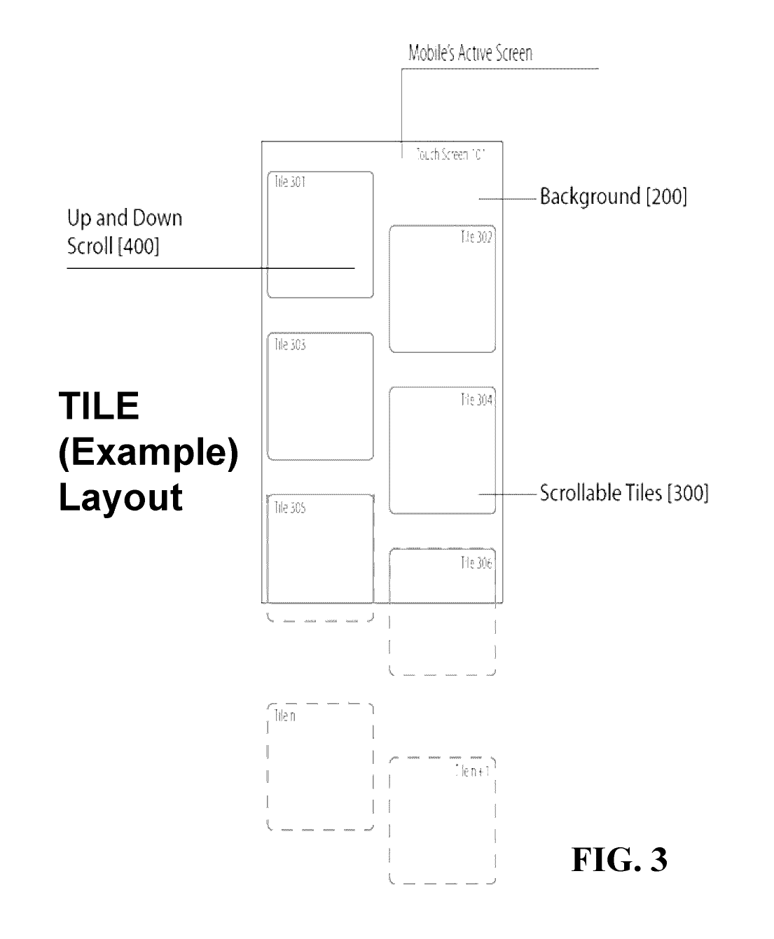

FIG. 3 shows the composition of each response containing a variable number tiles, a background image as minimum elements.

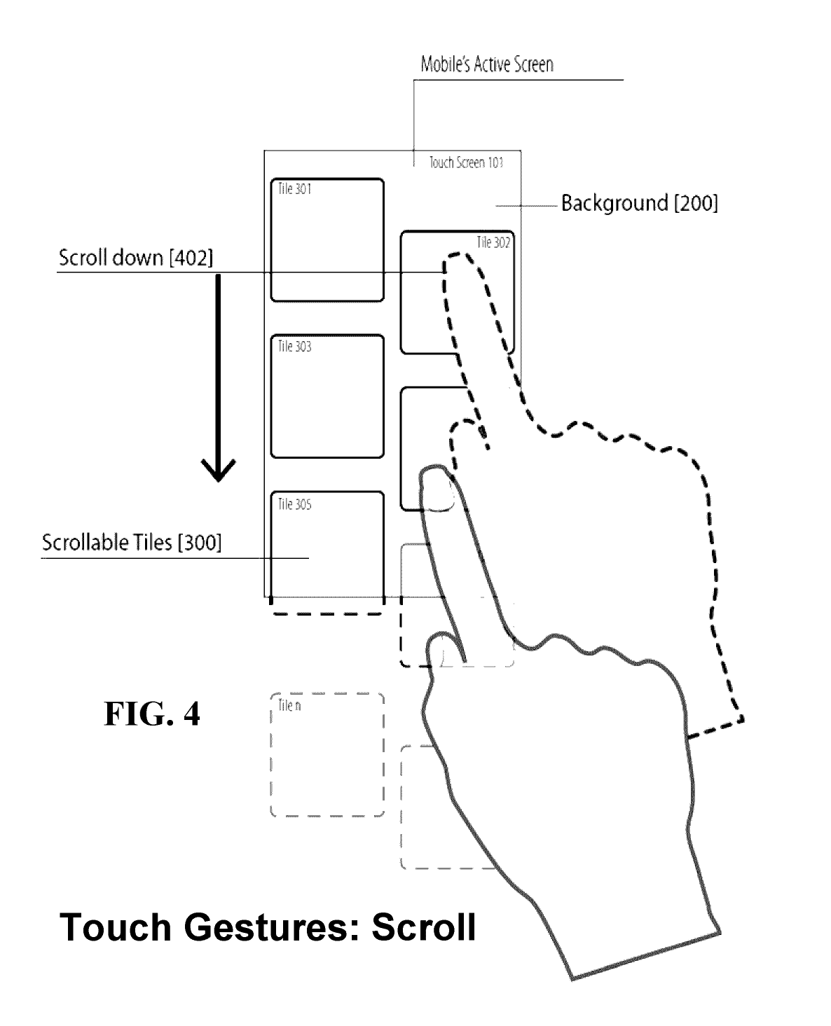

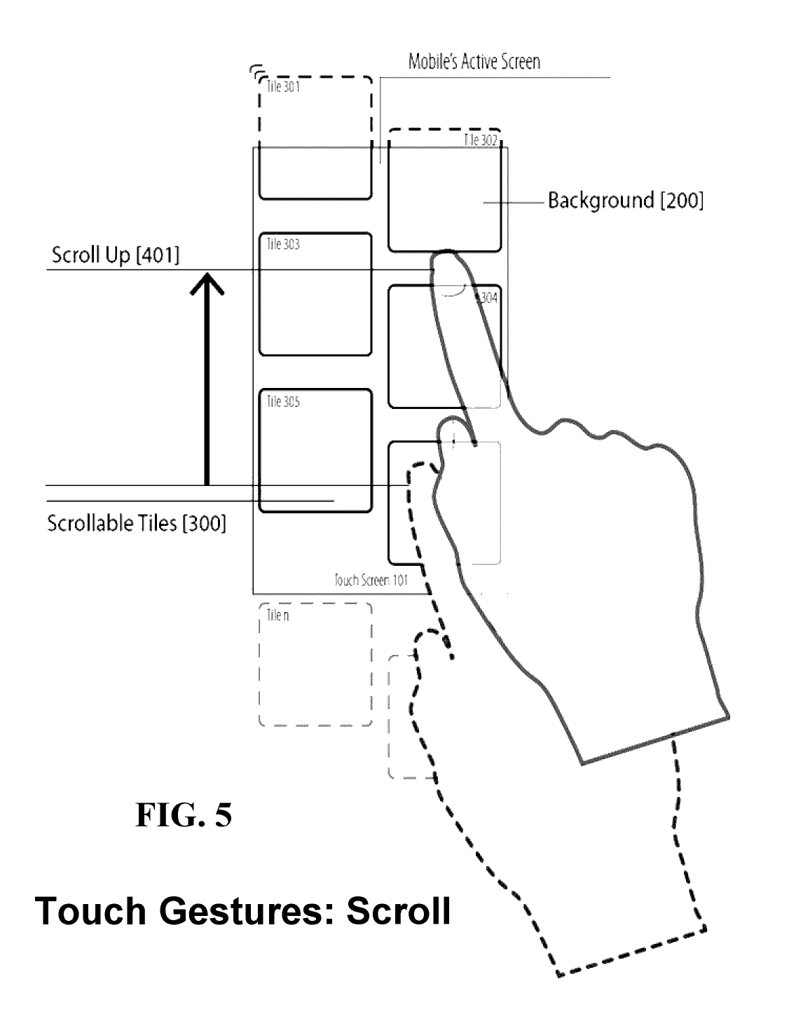

FIGS. 4 and 5 show how mobile users can scroll the contents up and down when these contents are too big to fit in the screen.

The proposed layout provides an effective design to display information on mobile devices and is an effective tool for enabling quick response to gestures by the users of the devices in a way that makes them more memorable and more easy for the viewers to understand.

The proposed layout comprises square or rectangular shapes called “tiles” which are positioned on the screen of any mobile device (Tile 301, Tile 302, . . . The n+1) and each tile contains a message with an optional background image, or a flat color and an optional foreground message which can be separated in 2 parts; title and message body. The tiles need not cover the entire screen and in the case where there is empty space between them, this can be filled by displaying for example a background image, a background video, and/or the continuous video stream of what is in front of the camera of the device.

The set of tiles can scroll up or down to display more tiles with information, either maintaining the background the same or changing it. Each tile when tapped by the user is expanded to display more information on the screen of the device. The expanded tile can display a web page, video, a collection of images in the form of an album, interactive forms to allow users to submit more information to the extent that this is allowed by the operating system of the device.

The proposed layout is an evolution of traditional lists of bullet points of text when combined with an intelligent easy and quick to use web page authoring environment. It is very effective because users can understand where each message begins and ends.

The use of pictures in messages where appropriate can both enhance the emotional reaction of viewers, and enhance its memorability, resulting in an overall more useful communication for both the broadcaster and the human viewer—receiver.

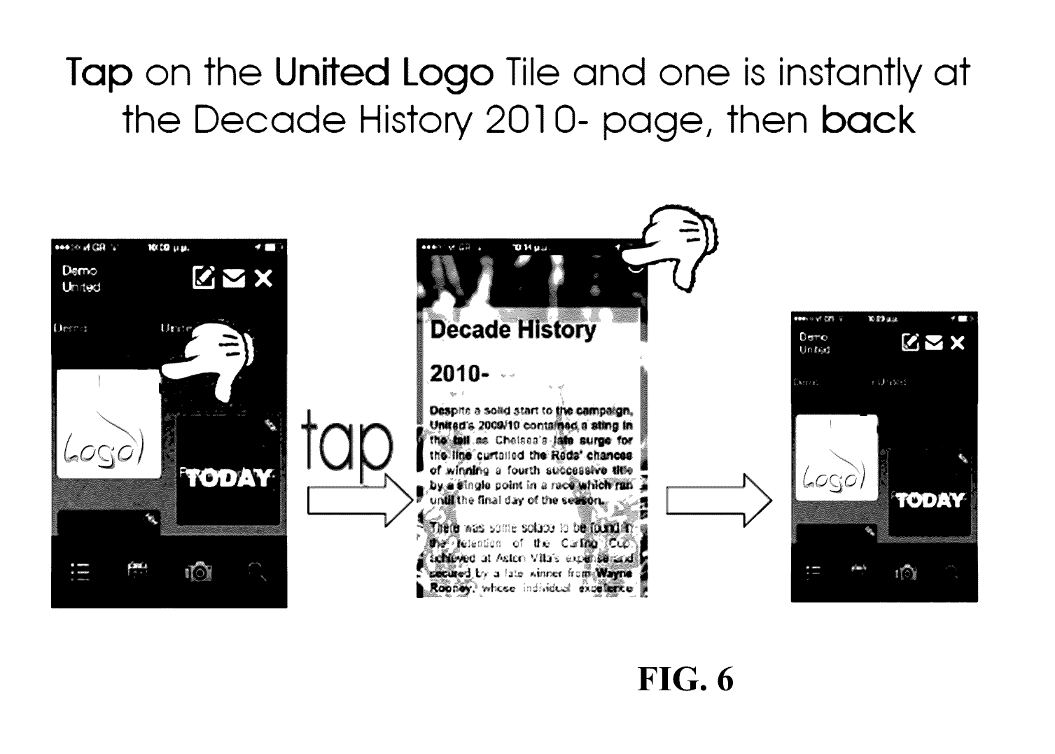

FIG. 6 shows how mobile users can tap on each tile to quickly access more information, and then return to the main screen with the initial tileset.

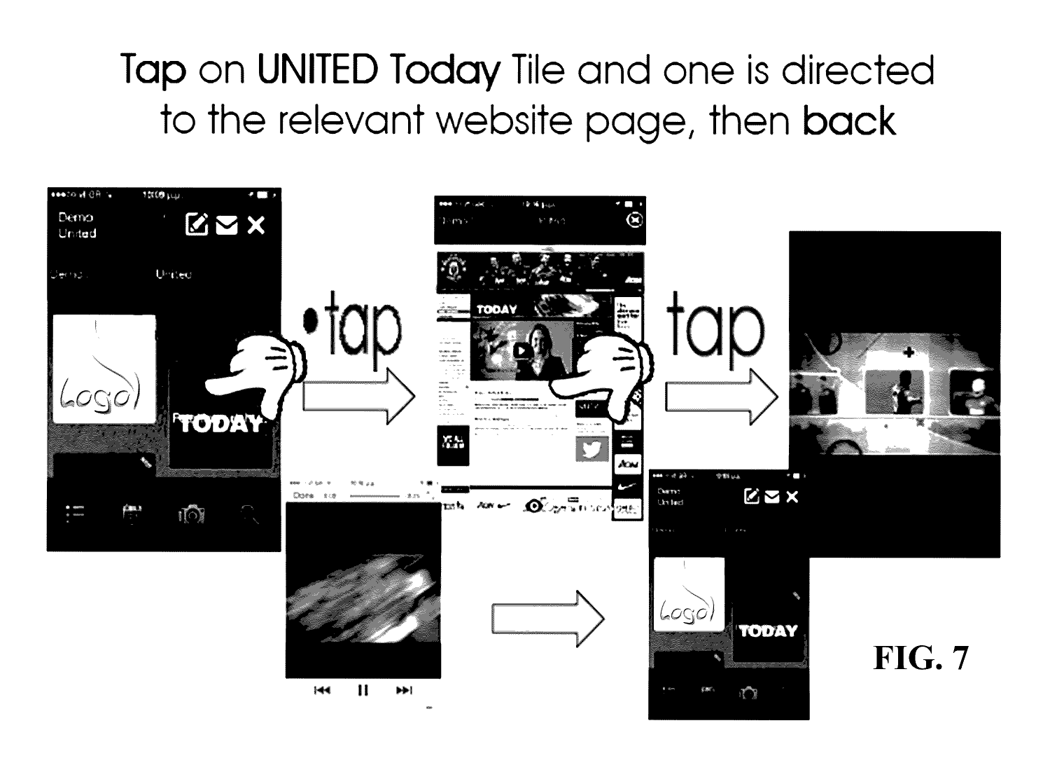

FIG. 7 shows how mobile users can access video and mobile web pages by tapping on tiles.

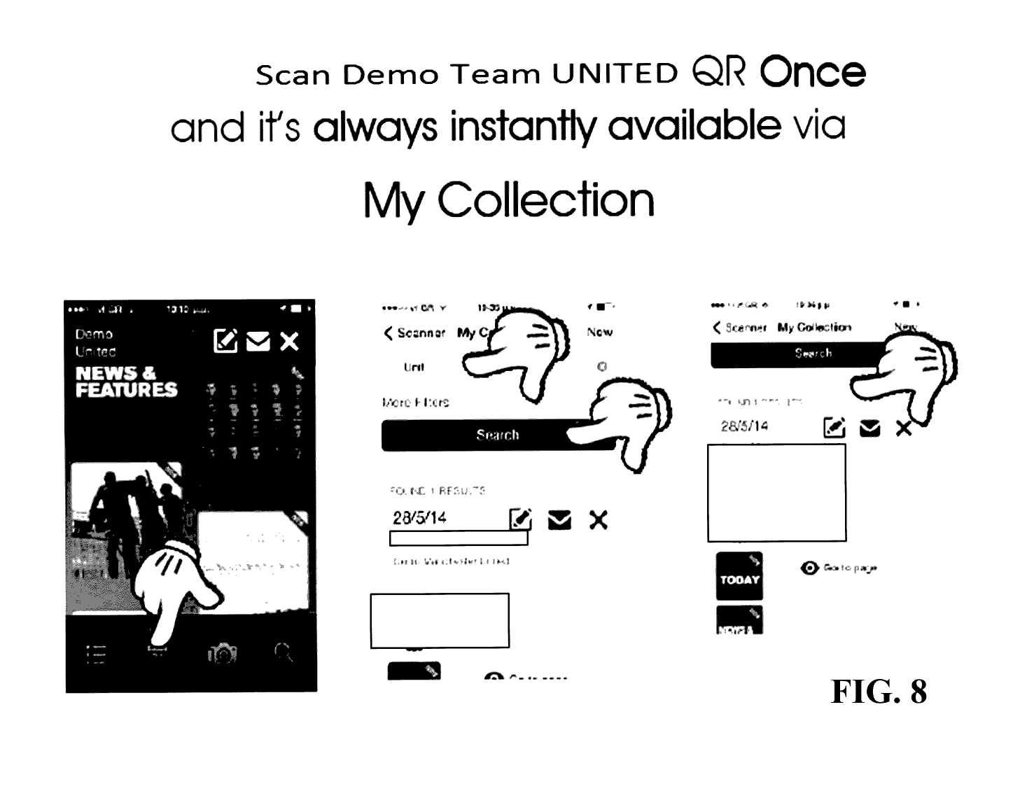

FIG. 8 illustrates the collection feature; when users scan something, the tileset which is generated in response, is kept in the user's collection. This collection is accessible for the mobile user by tapping on the collection icon. This image also shows how the collection can be searched with keywords.

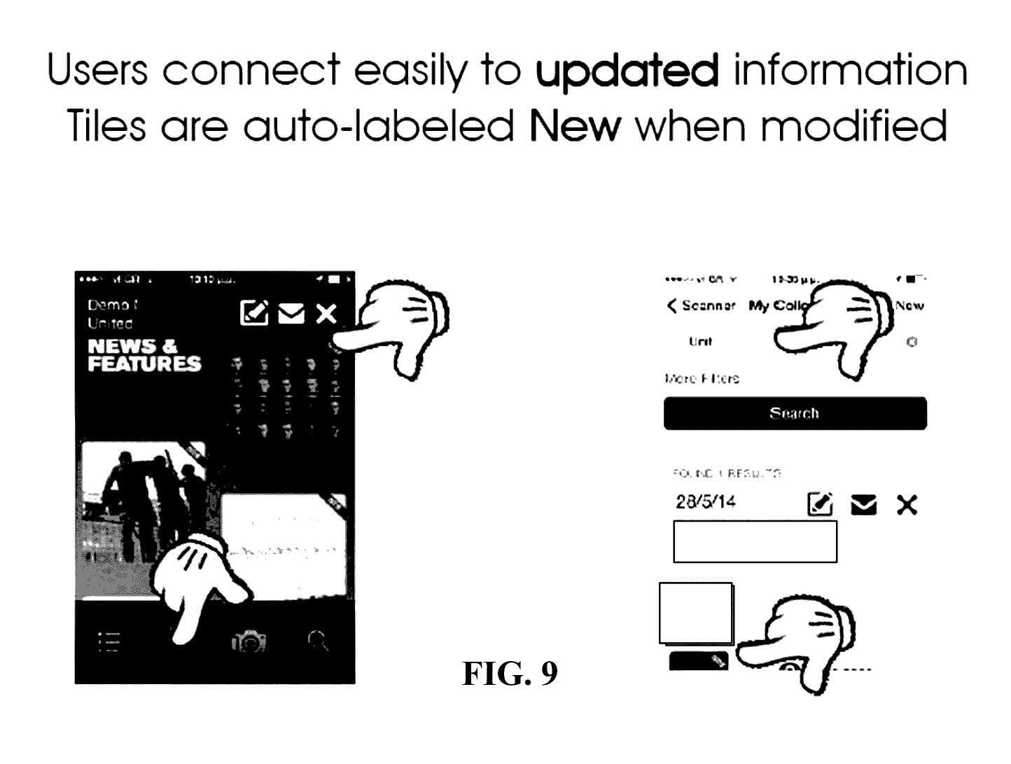

FIG. 9 shows how the information in the user's collection remains updated and contents displayed contain what the MALLFOX subscriber company has prepared up to that point.

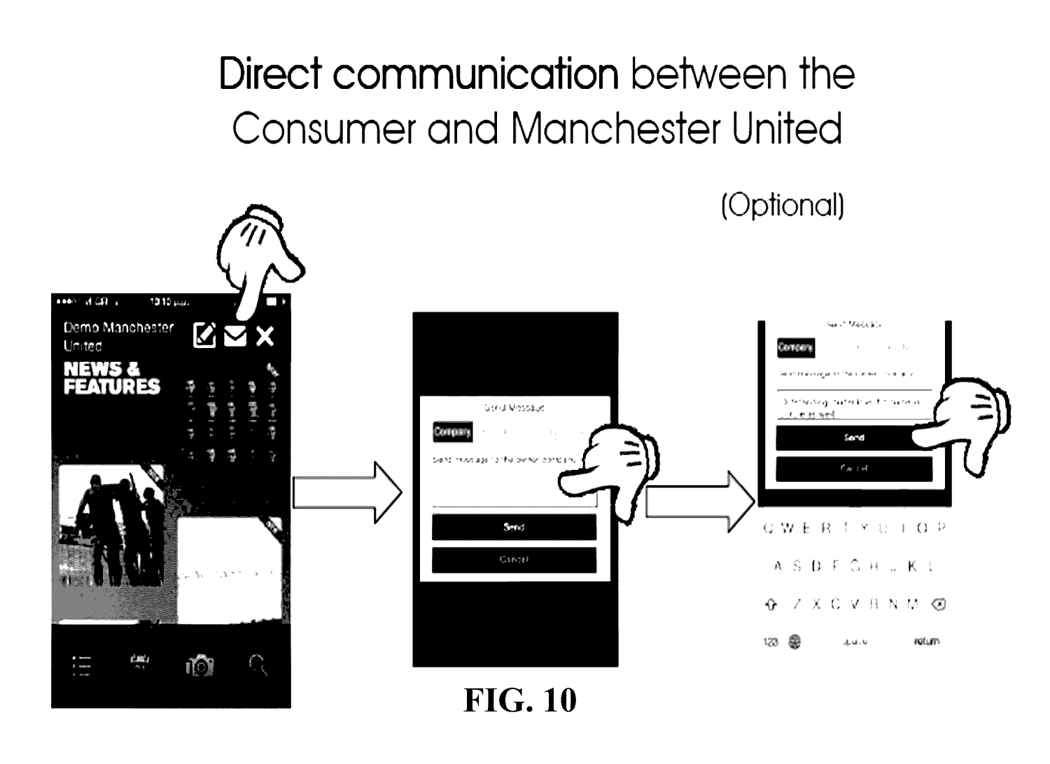

FIG. 10 shows the ability of each user to share the content of their scans by tapping on the envelop icon, and adding a personalized message.

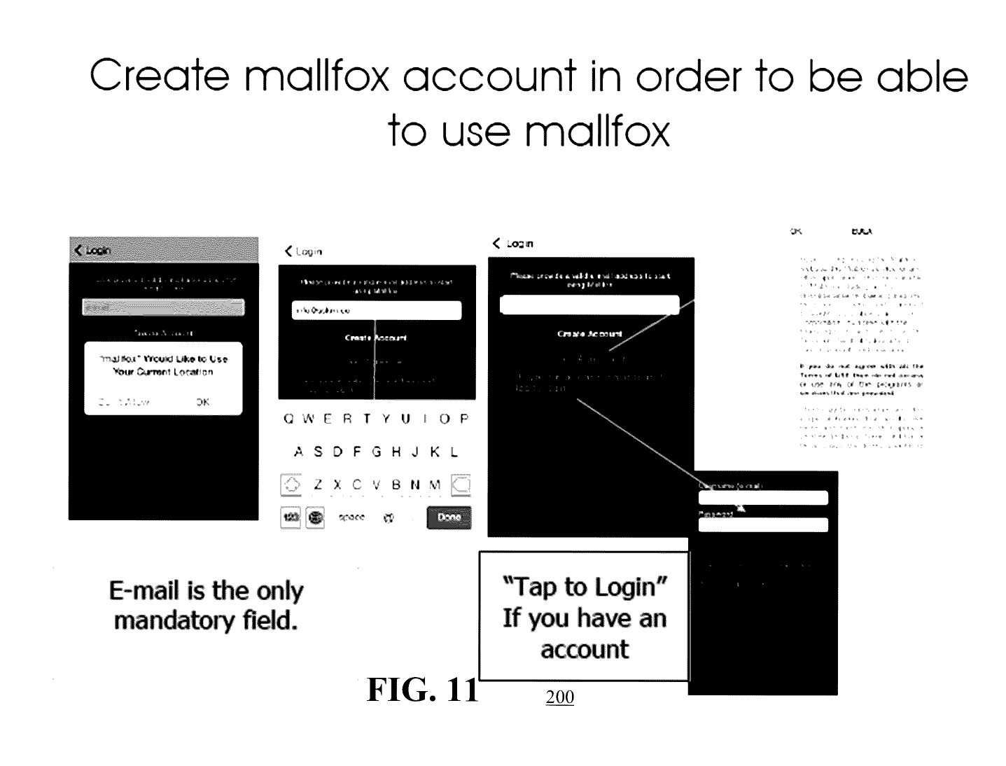

FIG. 11 shows the start enrollment of the user. A password is generated as to make enrollment easier by the mobile device. Afterwards to use the same account in the web interface and tablet a forget password is necessary as to reset the password.

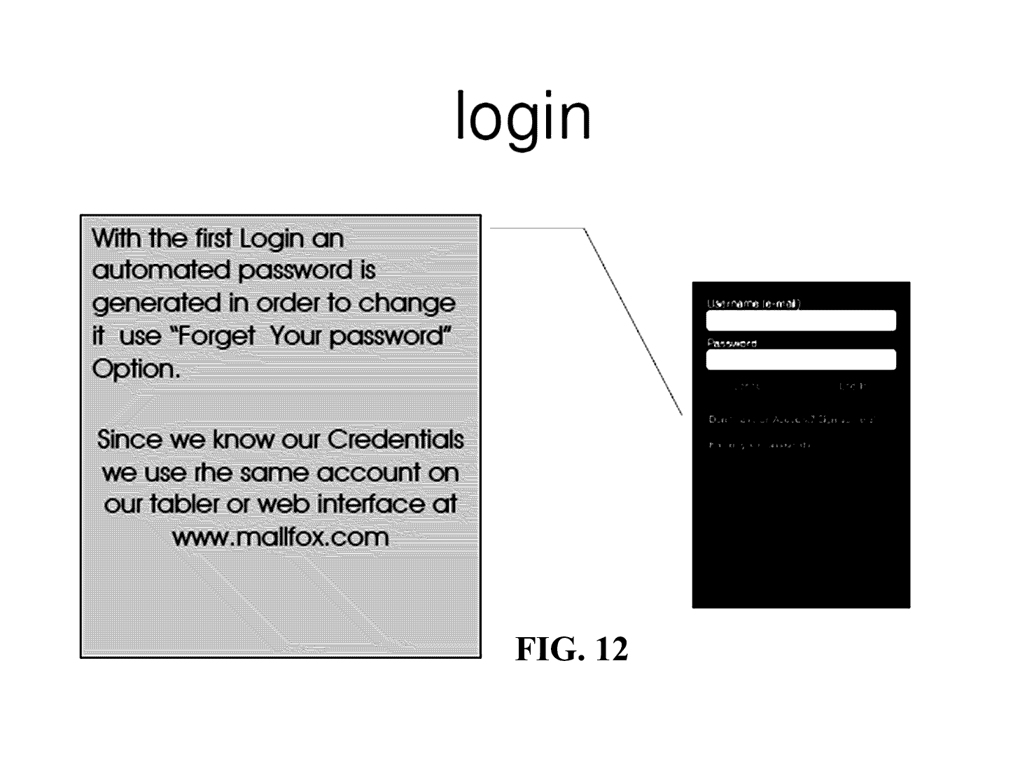

FIG. 12 shows the screen which mobile users use to provide their credentials and access their account.

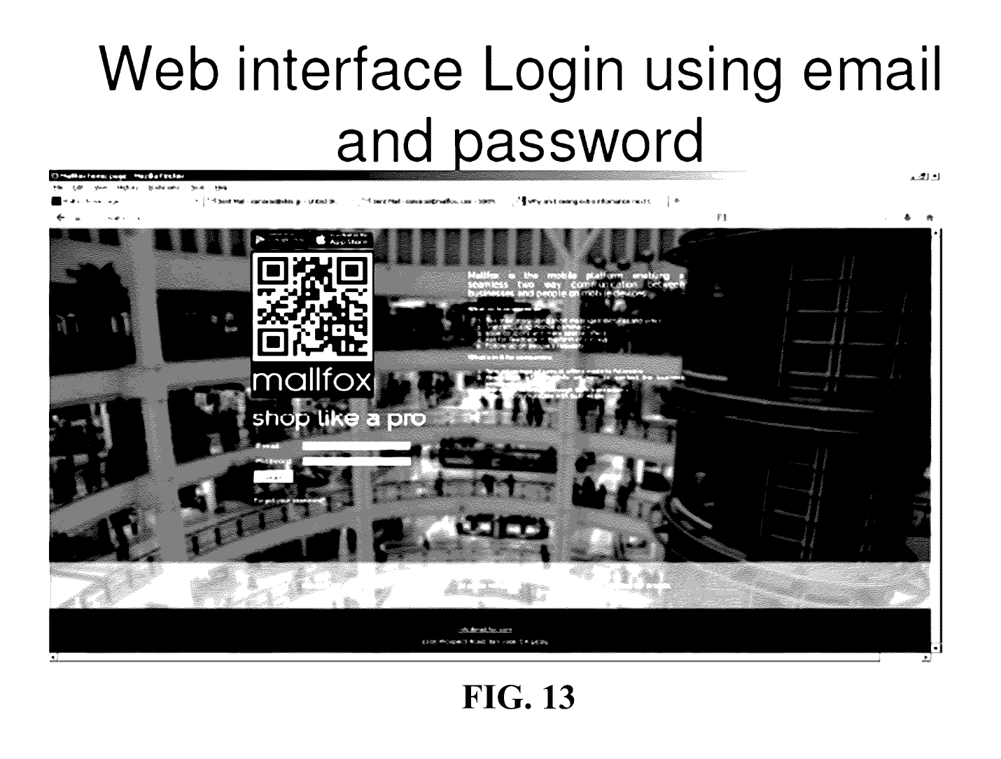

FIG. 13 shows the screen where consumers and content creators can provide their credentials and access their account. The system identifies users and directs them to other pages where they can use the system.

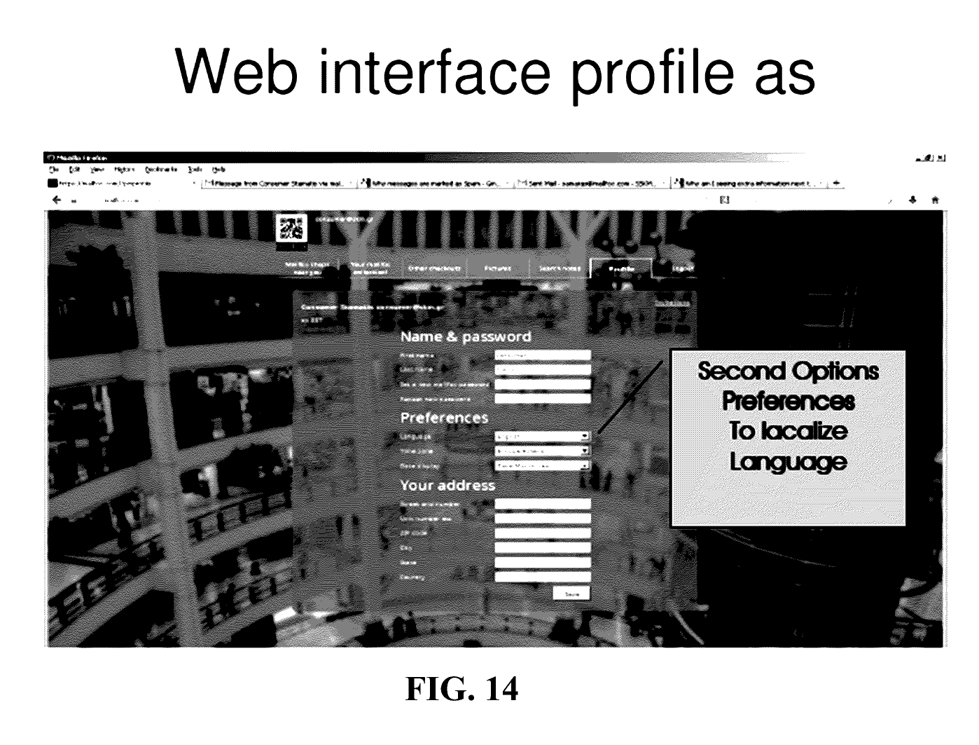

FIG. 14 shows the interface where users can update their personal information and their preferences.

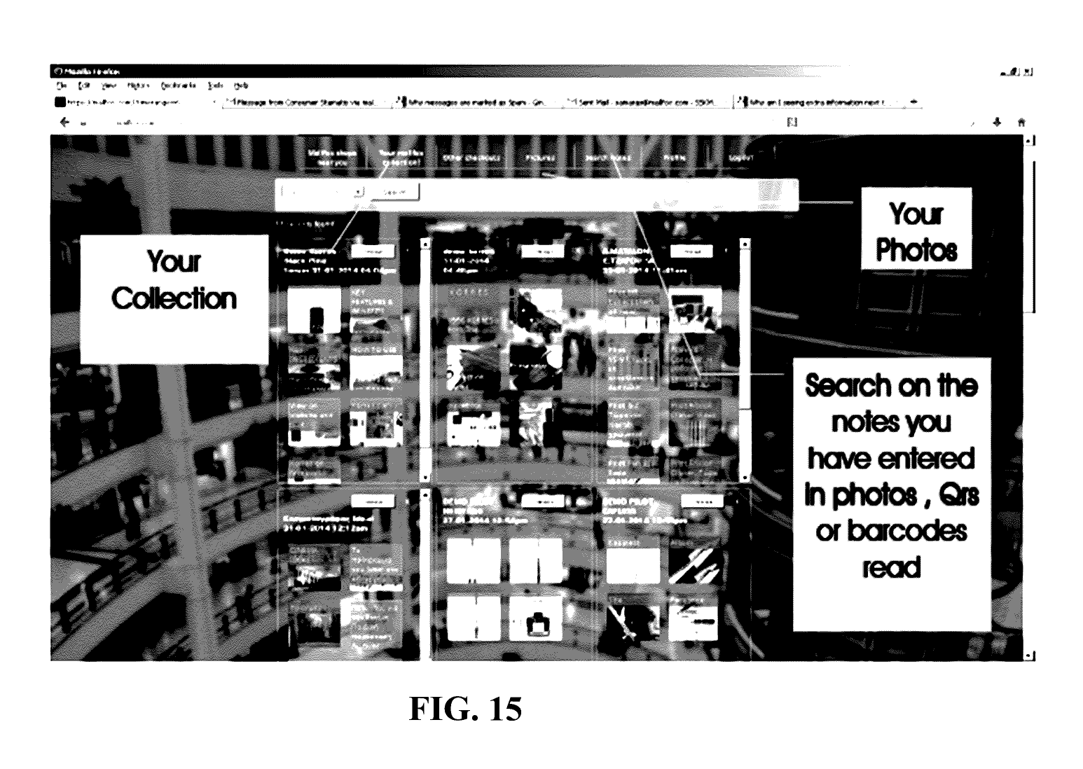

FIG. 15 shows how consumers can access the content of items they have scanned using a traditional desktop or mobile browser. The page shows sets of tiles corresponding to QR codes that have been scanned by a user using the MALLFOX mobile app. In this page users can search their collection of scanned items by providing a keyword.

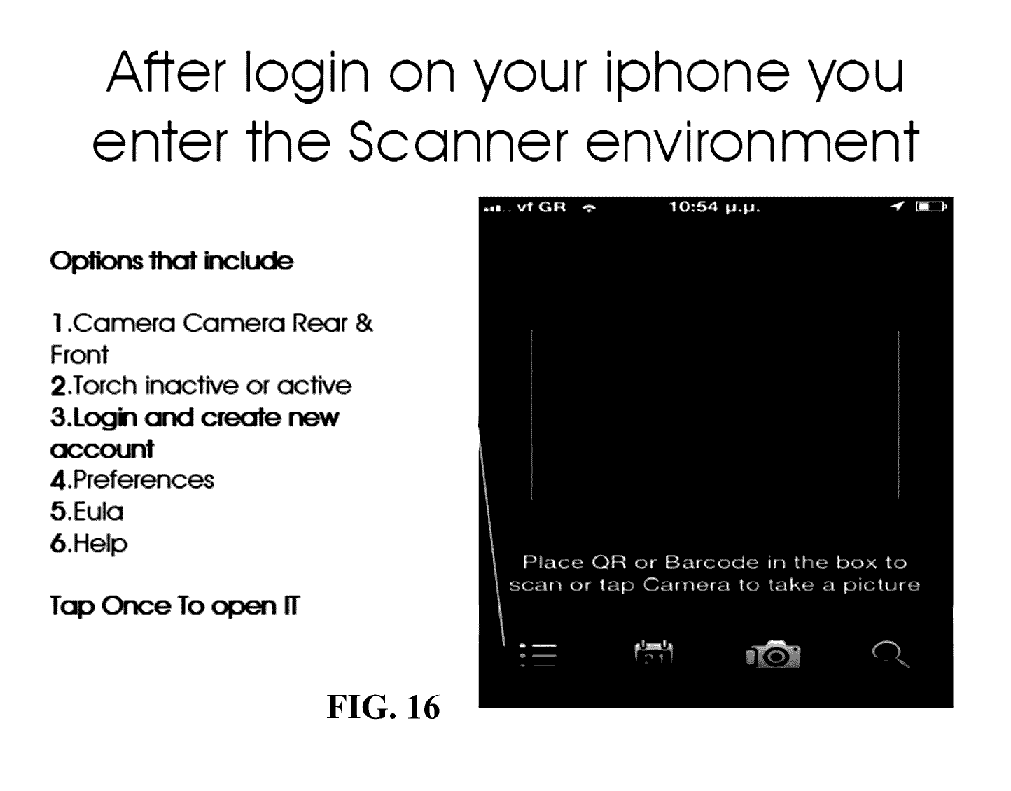

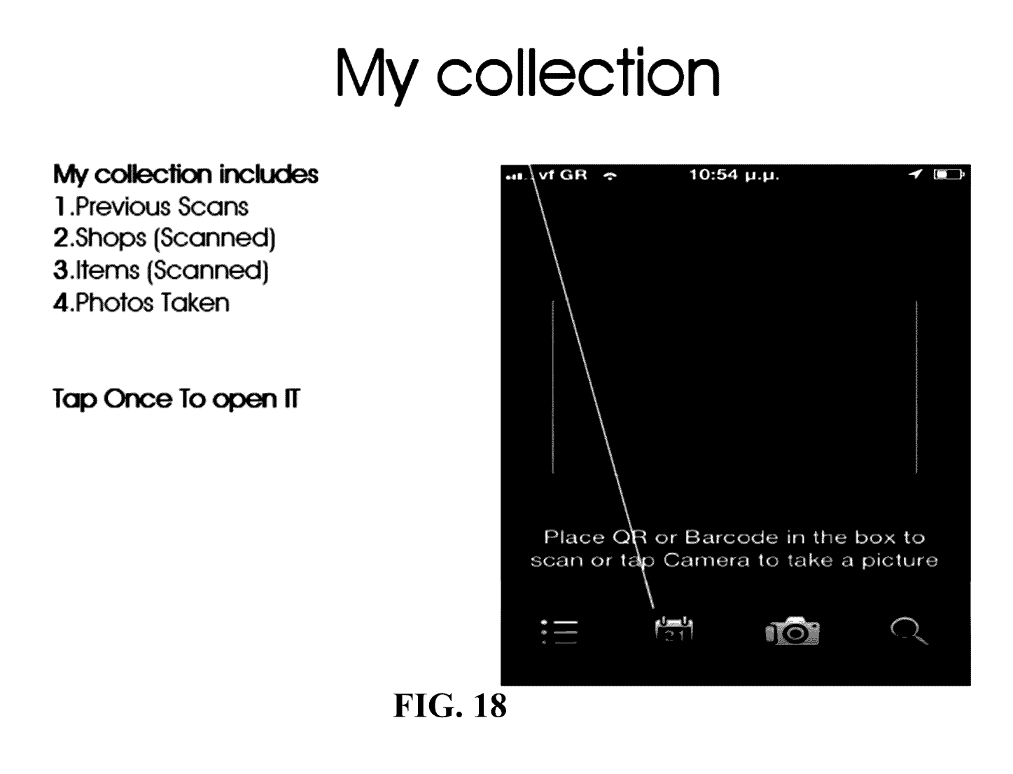

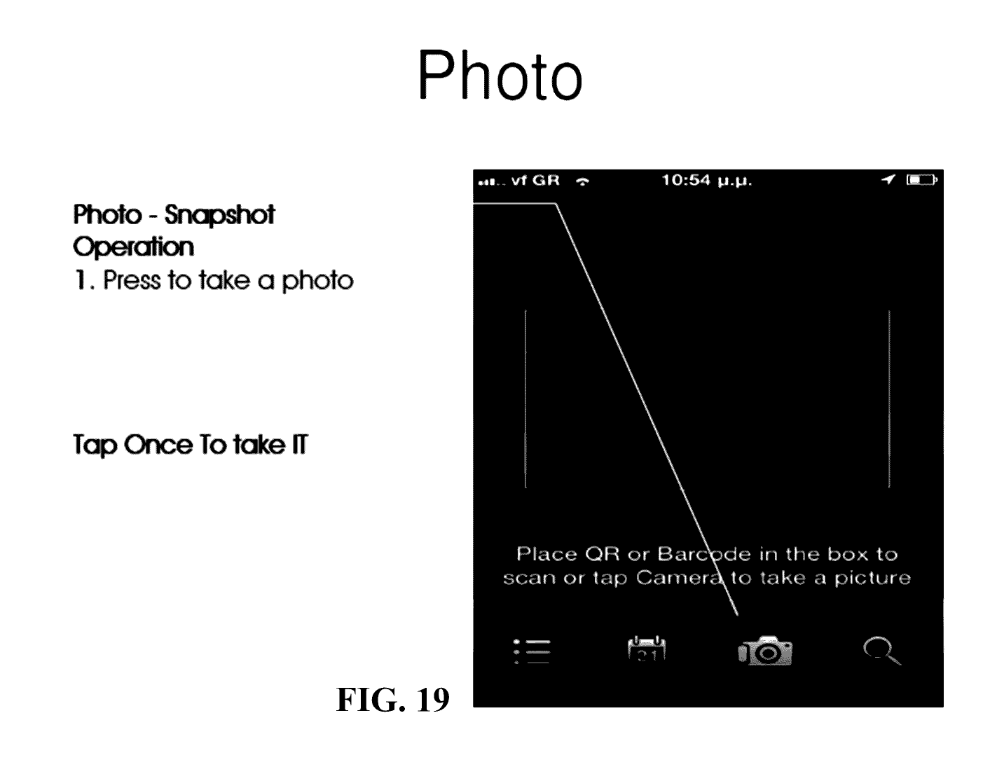

FIGS. 16, 18 19 and 20 show the MALLFOX mobile application after a user has successfully logged in, with four icons at the bottom of the mobile screen, allowing users to access and change their preferences, view their collection, add a photo to their collection and access the newsletter feature of the application.

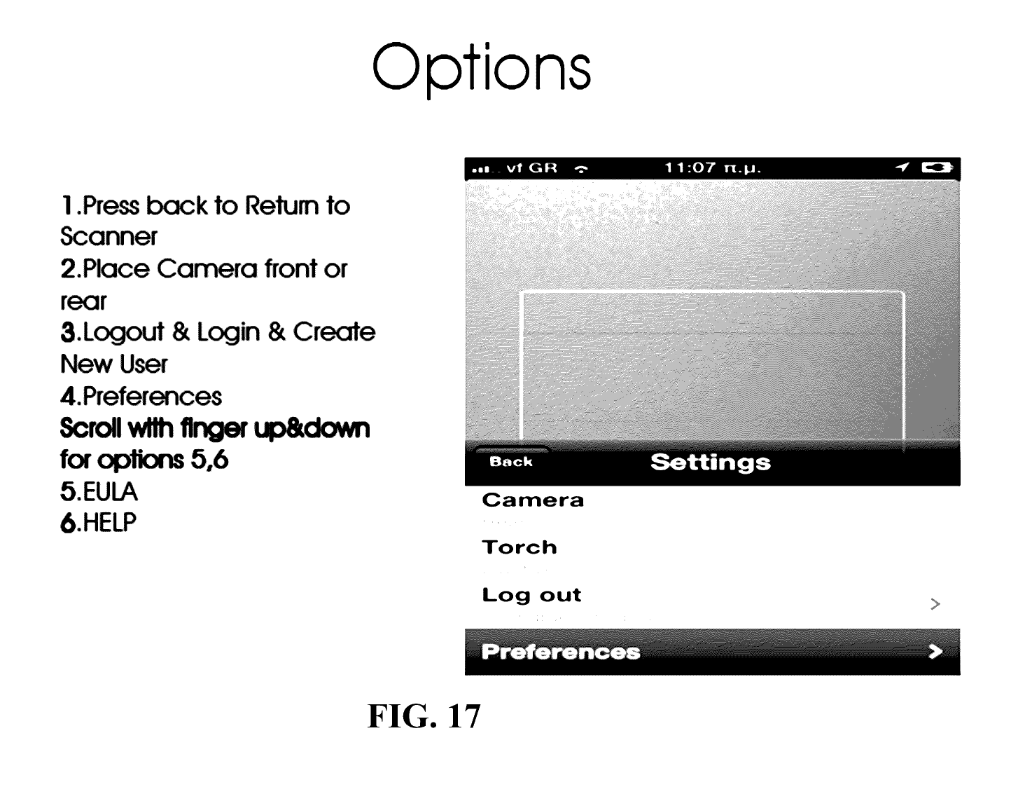

FIG. 17 shows the basic options offered to mobile consumers, which are to scan bar codes using the front or the rear camera of the device provided that the mobile device has these hardware options, light up the flash of the front camera of the device, log out of the device and access other preferences.

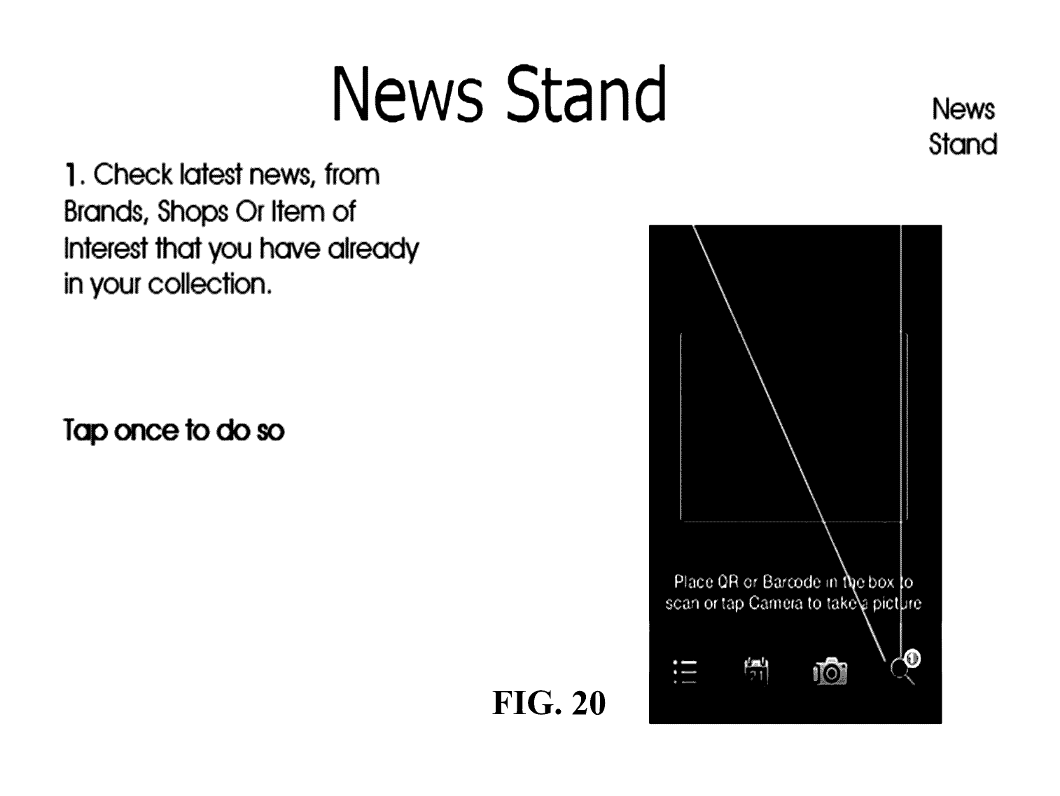

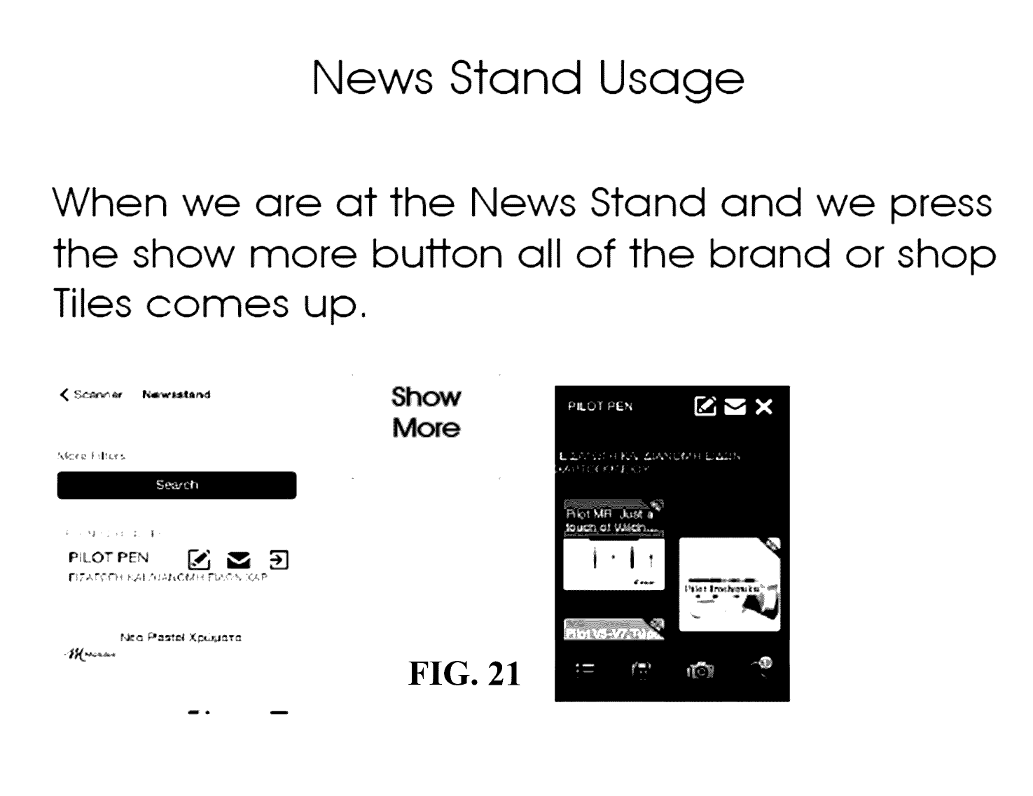

FIG. 21 shows the newsstand option of the mobile application, where users can find a personalized collection of news that come from QRs that mobile users chose to keep in their collection. In this figure, the short display of one news item on the left is shown, as is the expanded tileset which users can invoke by tapping on the designated “Show More” icon.

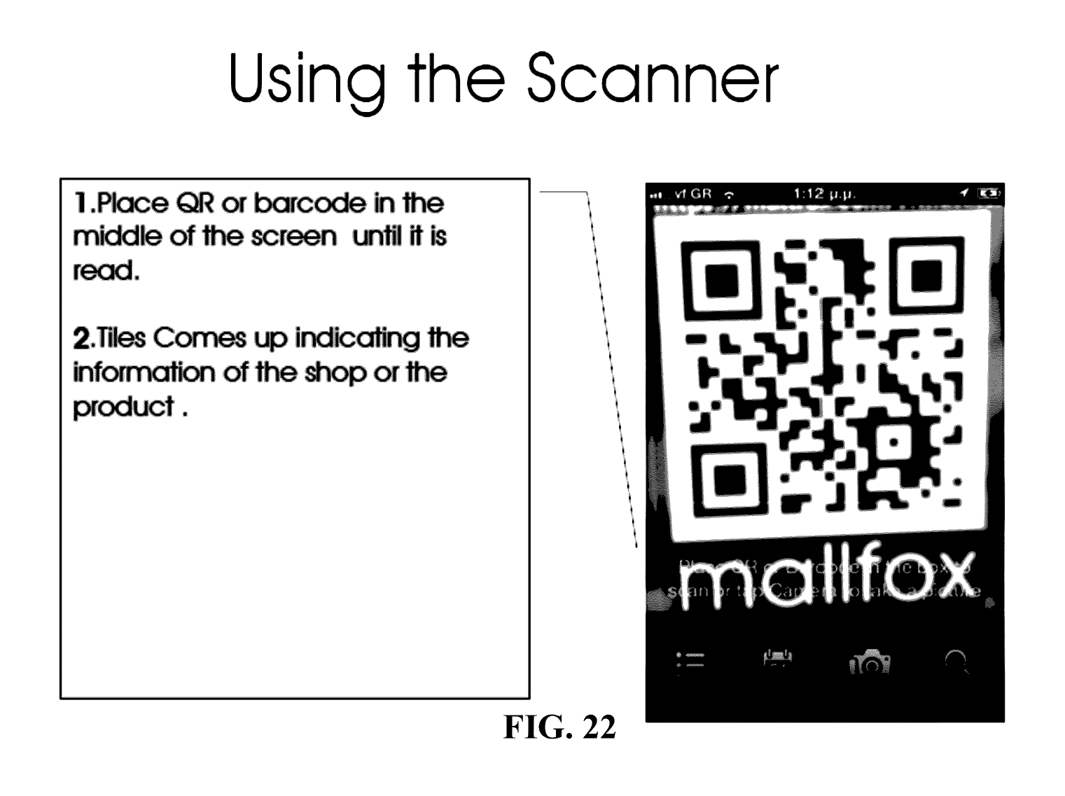

FIG. 22 shows how the mobile device application looks when a QR code has been placed in front of it right before the personalized tileset is downloaded and displayed.

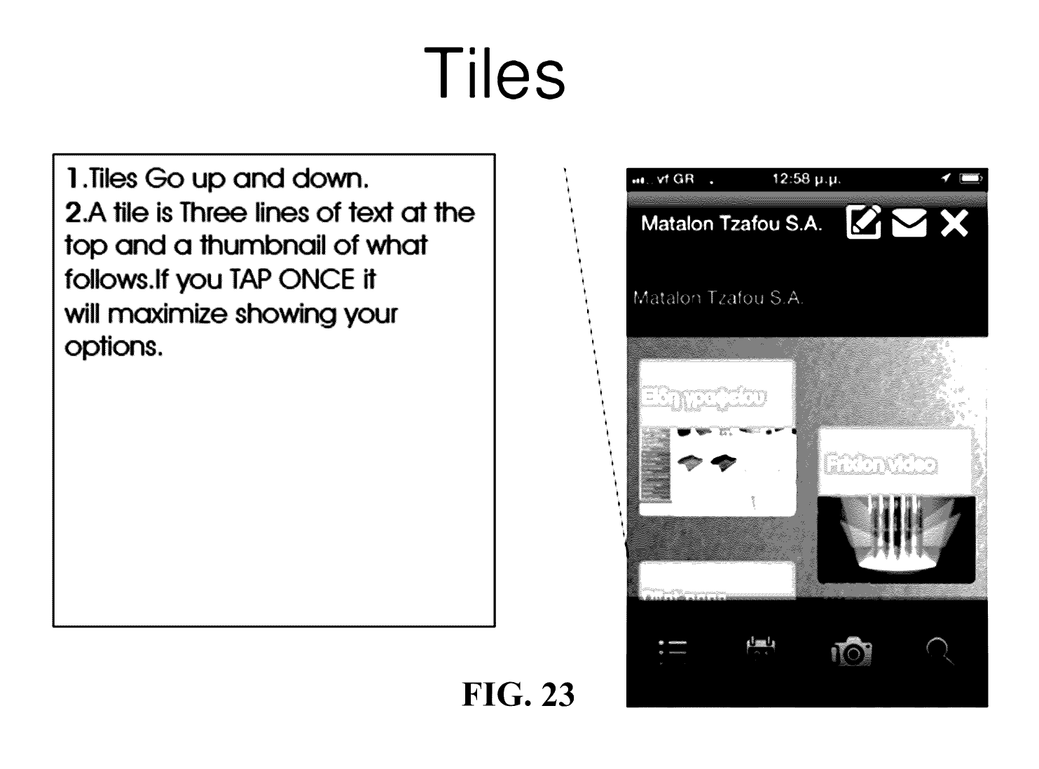

FIG. 23 shows the rendered personalized tileset which exceeds the size of the screen and can be viewed when the users scrolls up and down the screen.

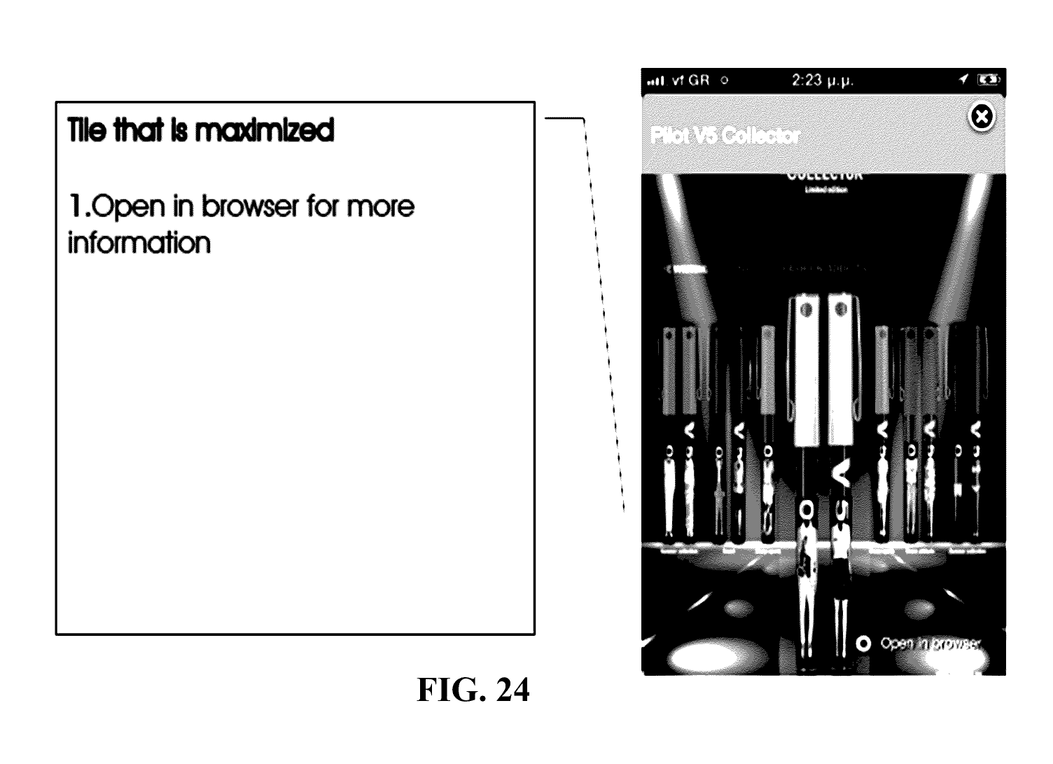

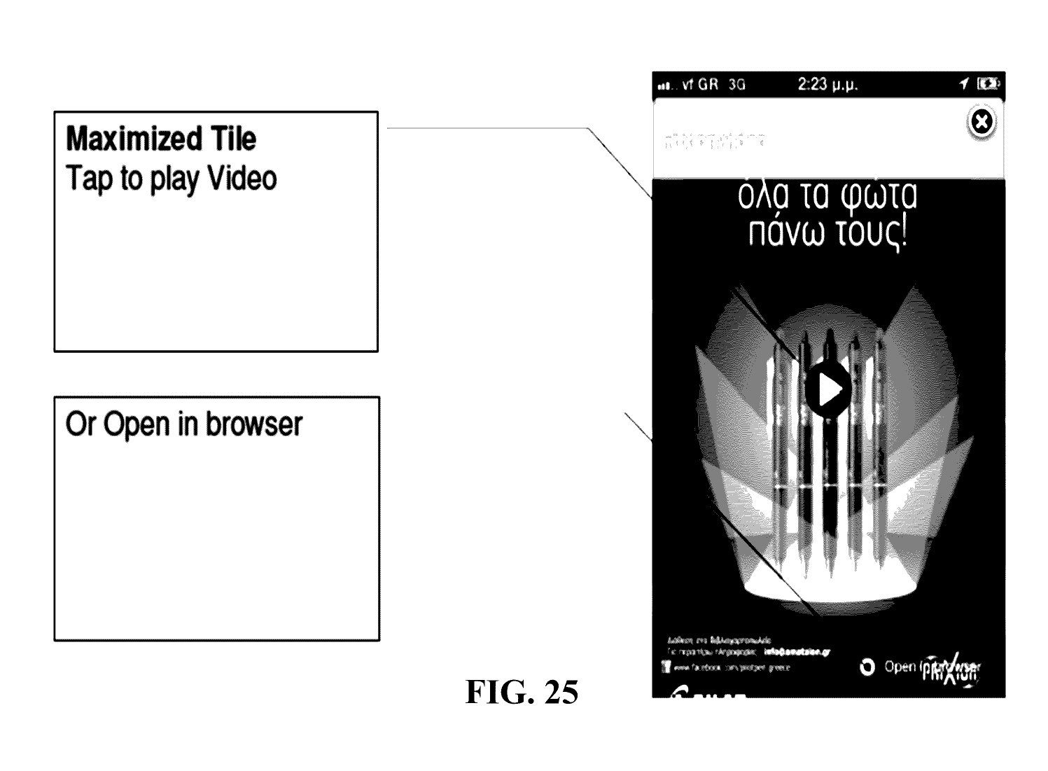

FIGS. 24 and 25 show the result of mobile users tapping on a tile, there being an expanded screen displayed with the relevant personalized information.

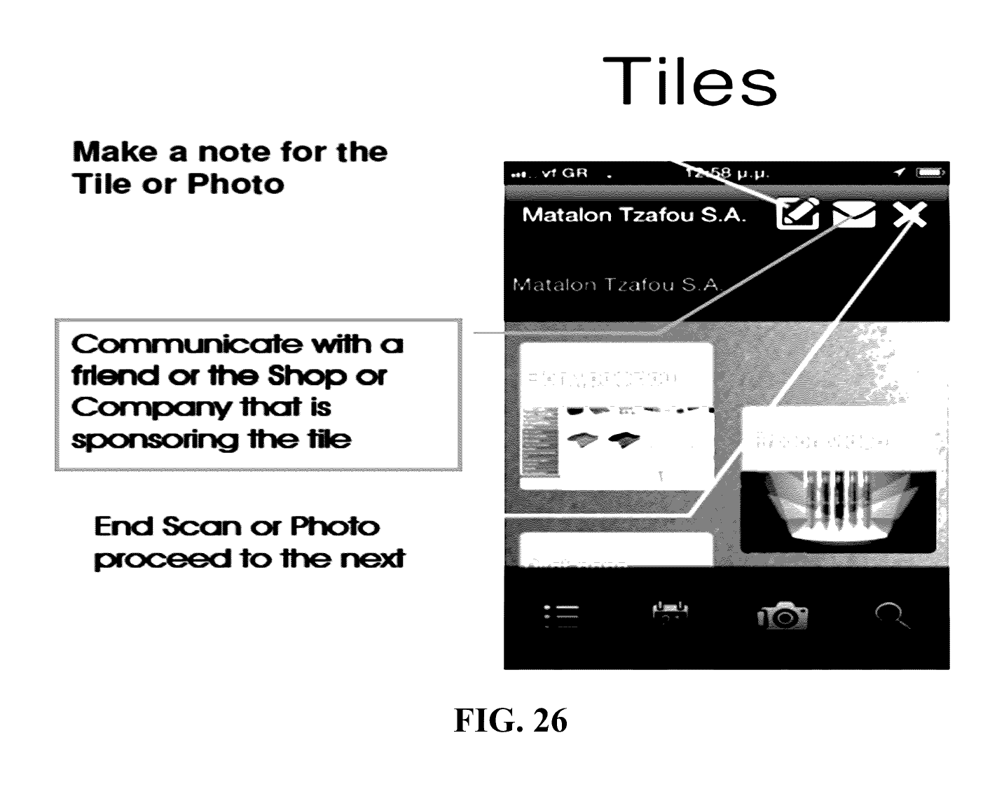

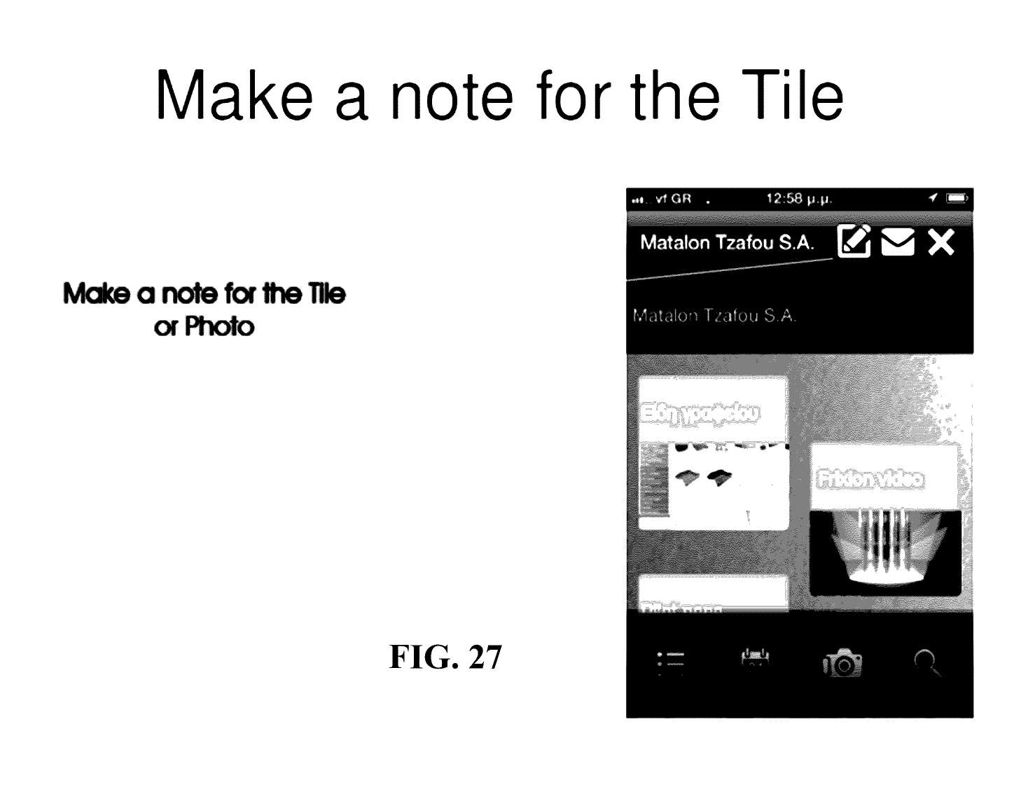

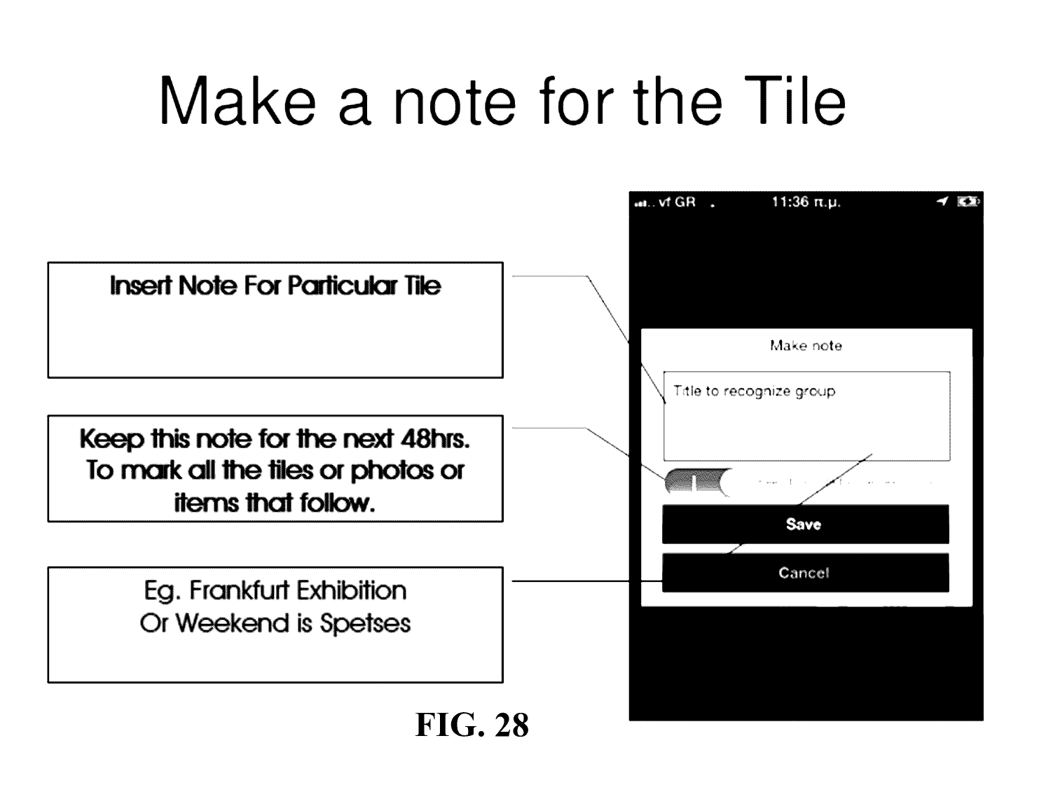

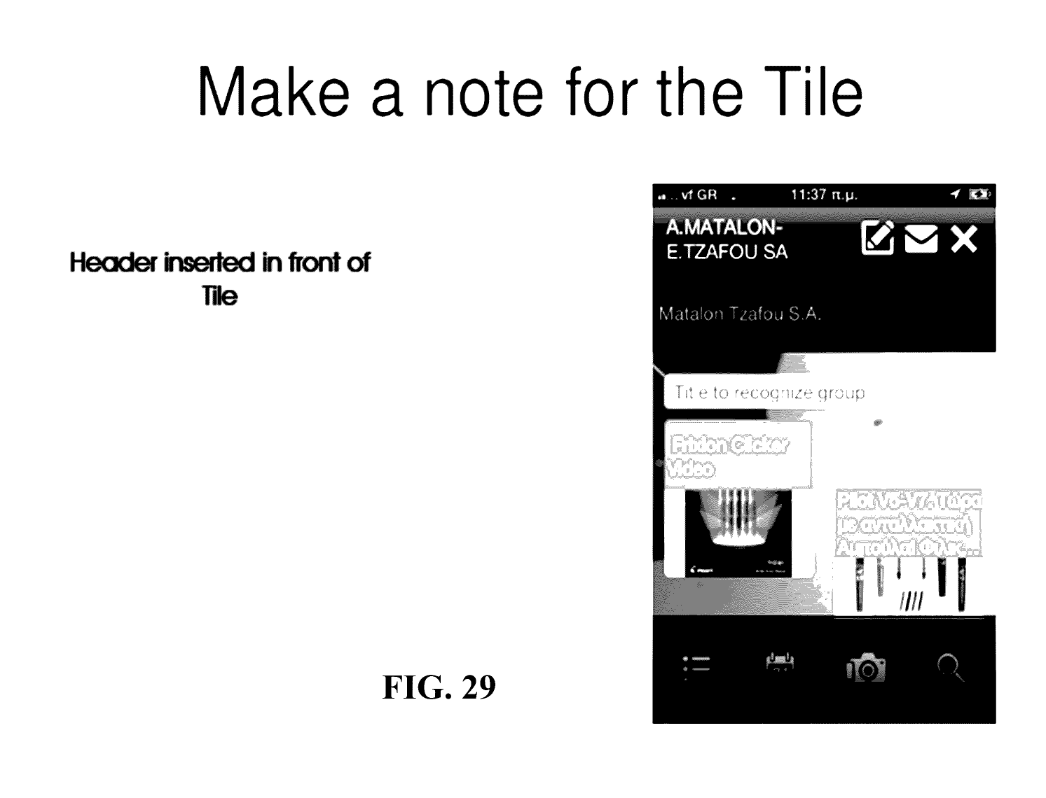

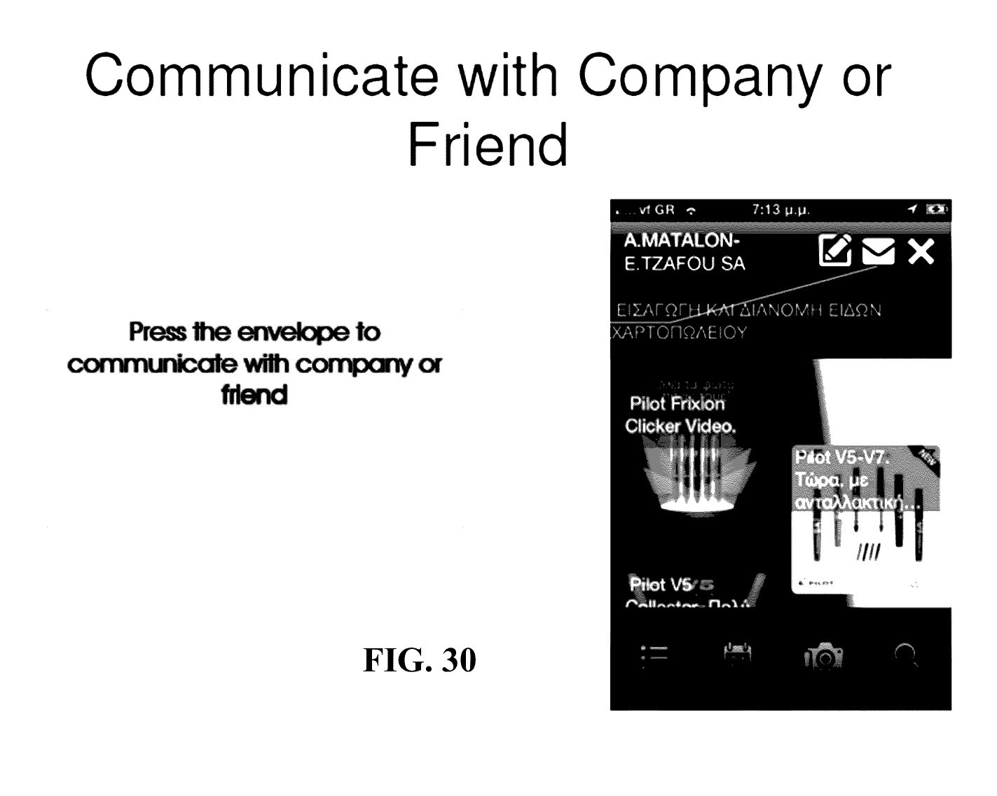

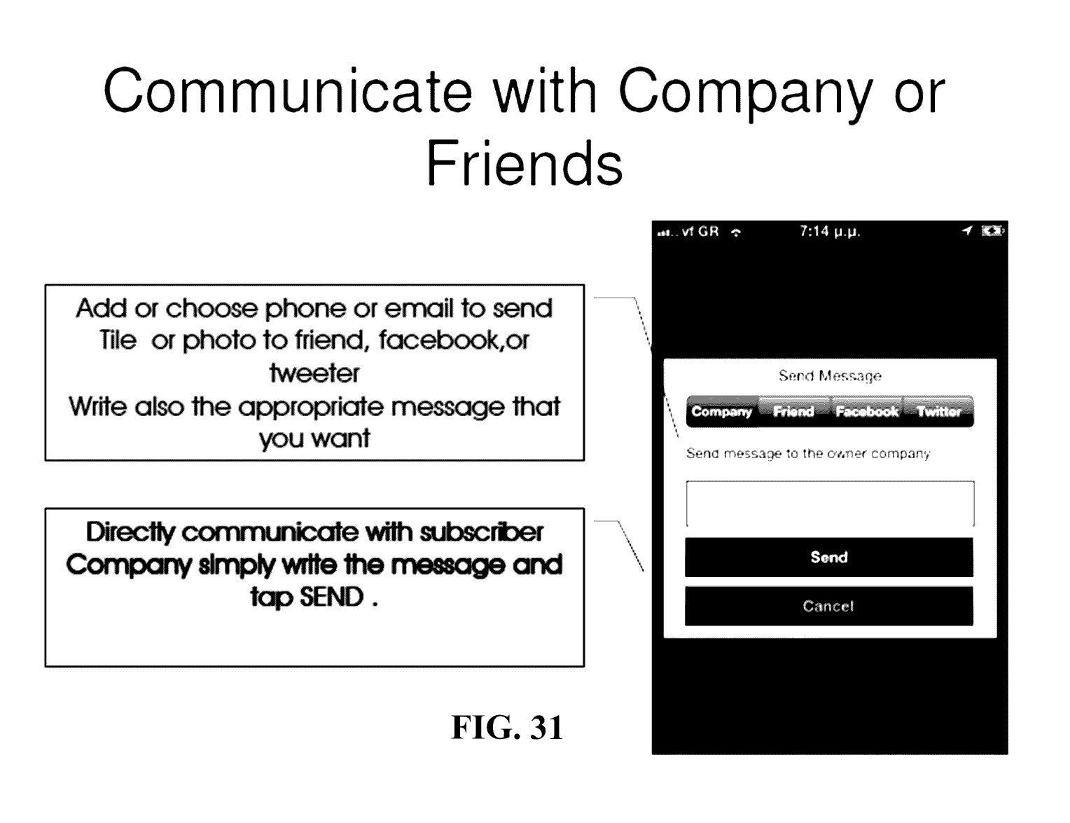

FIGS. 26-30 and 31 show how a user can choose to make a personal note related to this tileset, forward this tileset to another person, send a message to the creator-company, or close the tileset.

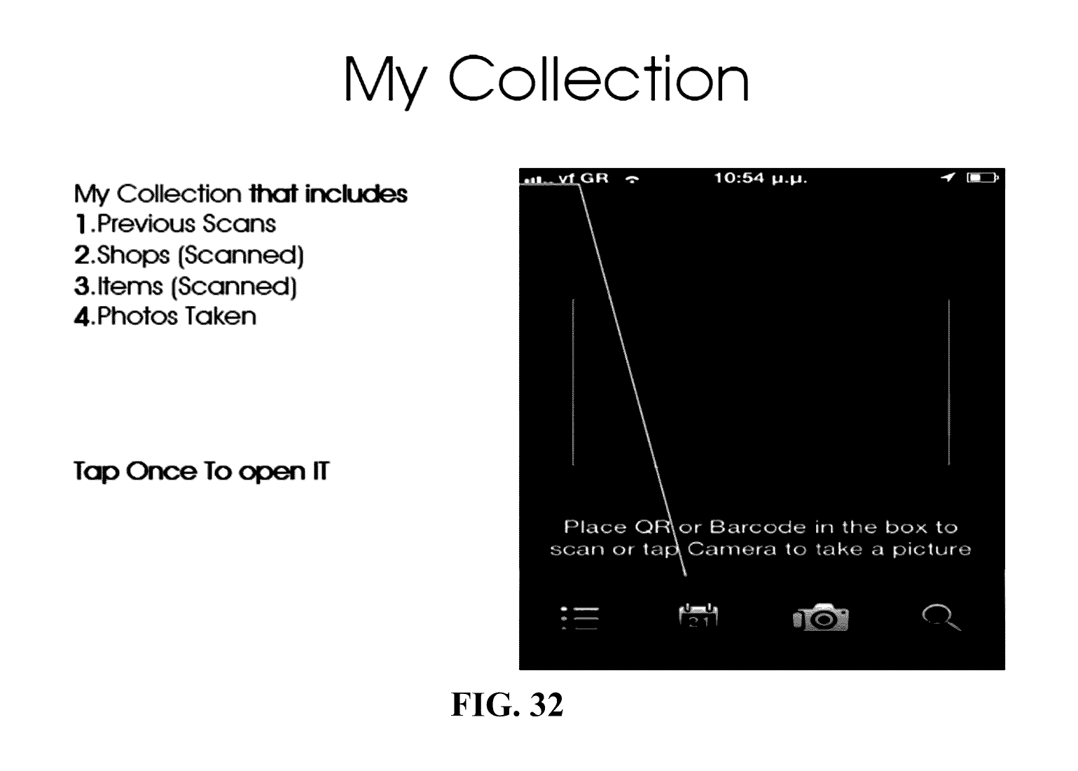

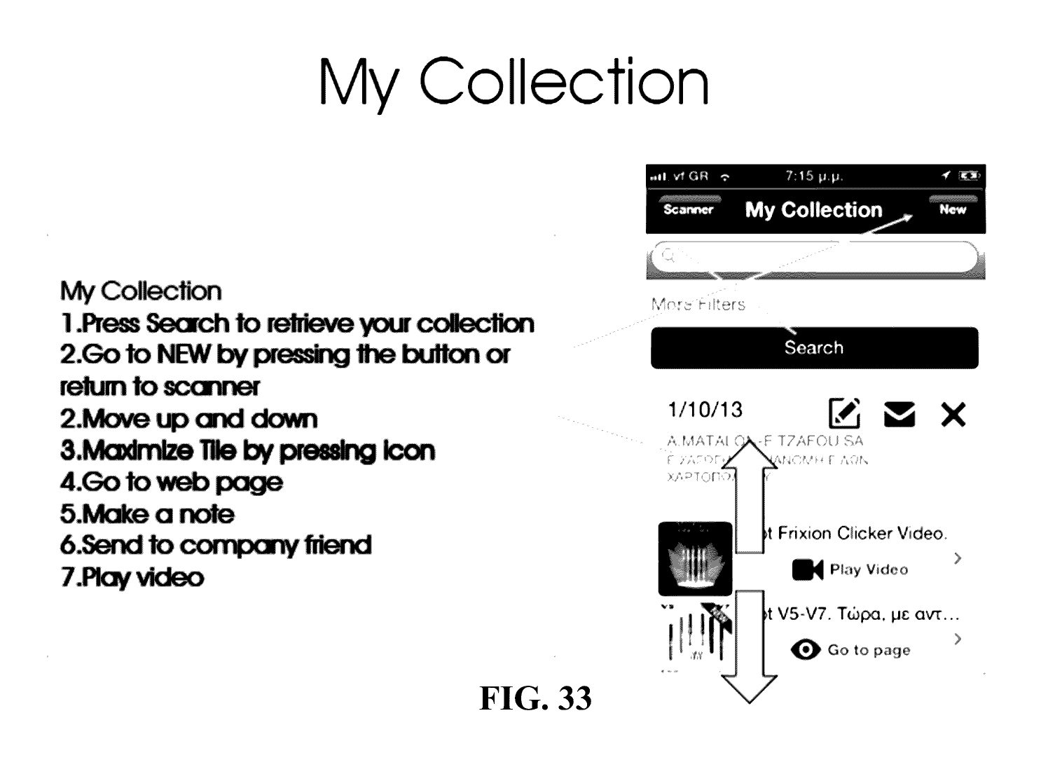

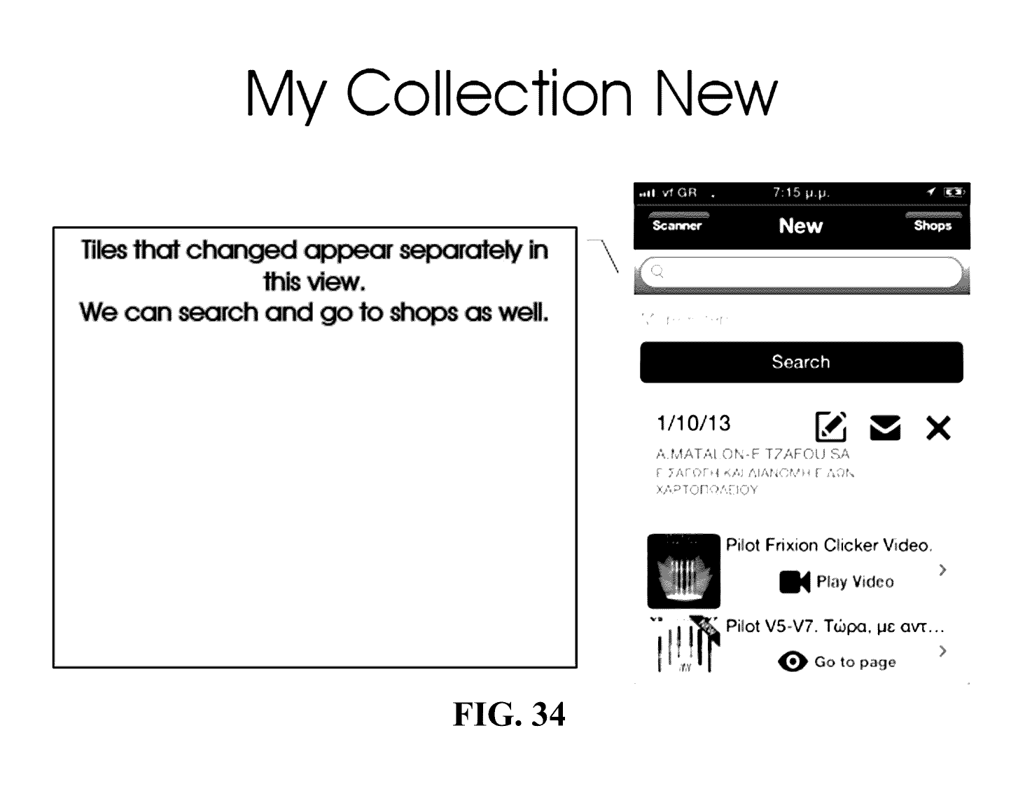

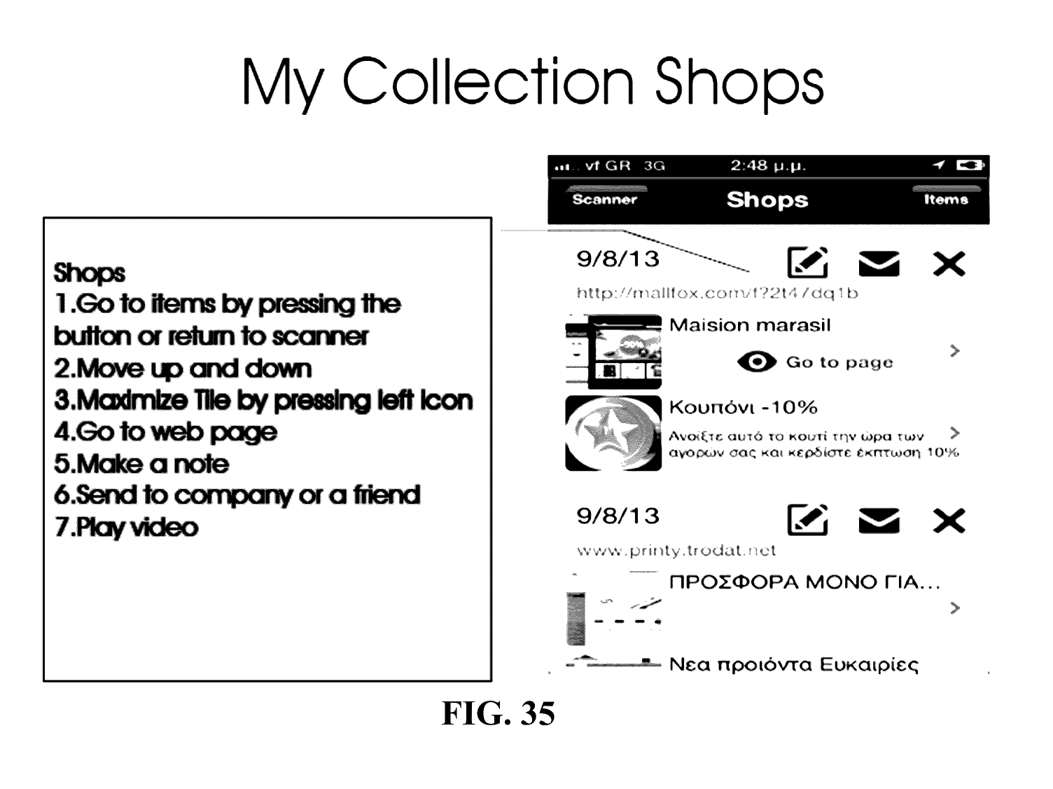

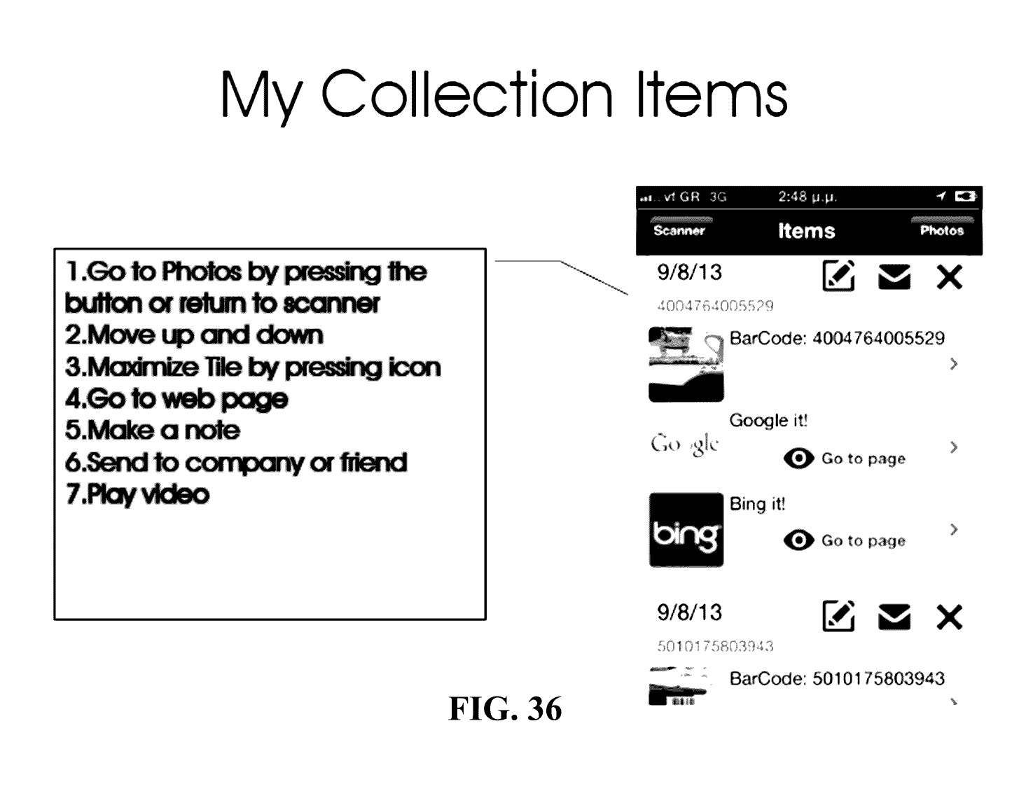

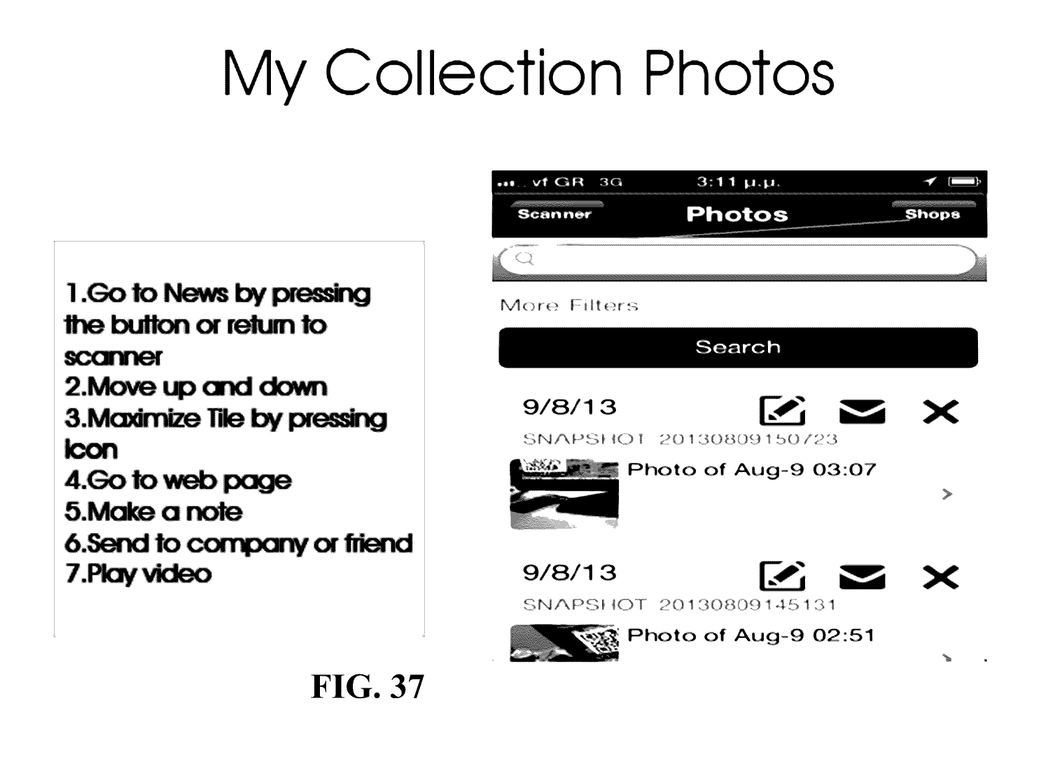

FIGS. 32-37 show how the users of the MALLFOX mobile app can access their personalized collection of MALLFOX scans and photos, viewing the updated information and filtering the results.

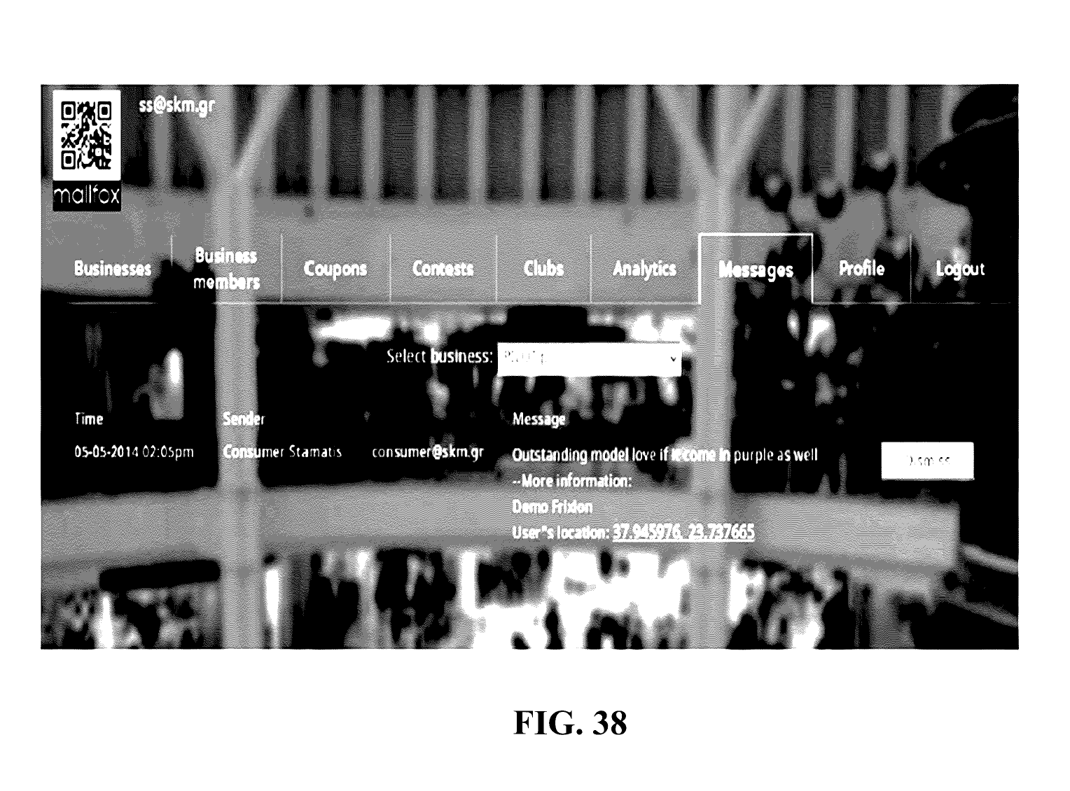

FIG. 38 shows the private web page which MALLFOX content creators can access and view all messages that have been sent to them by consumers.

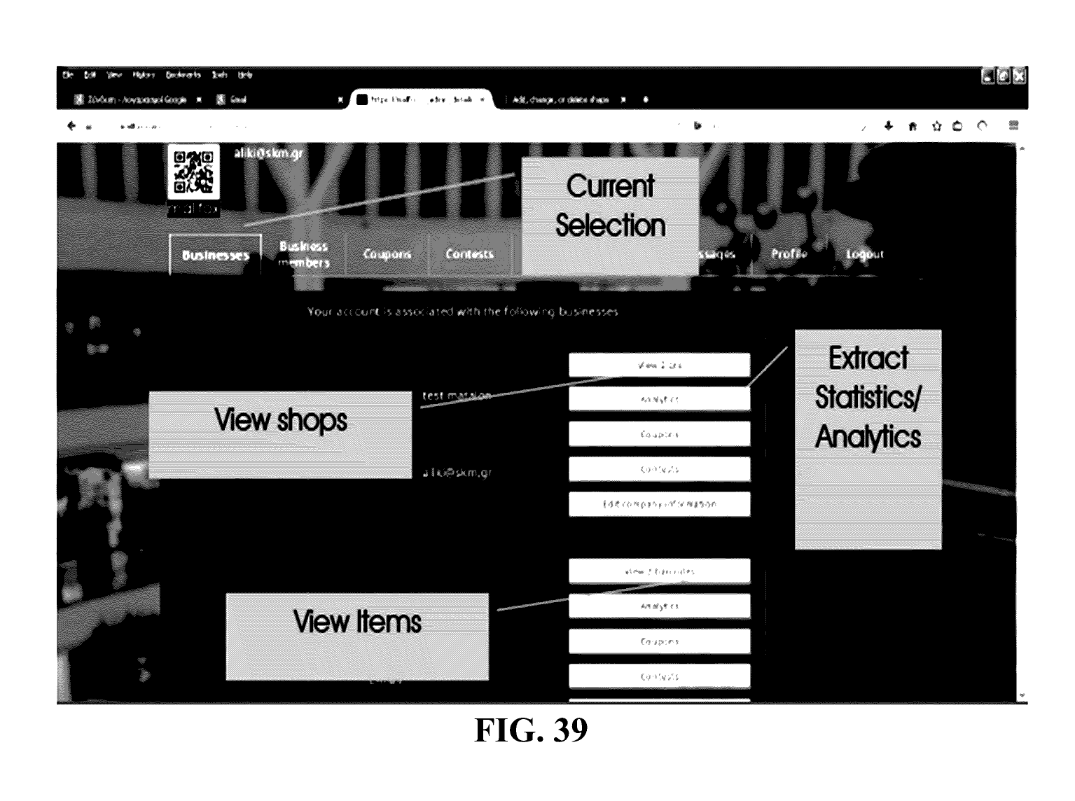

FIG. 39 shows the private web page where MALLFOX content creators can access and view the businesses for which they can create tilesets and access more detailed relevant information.

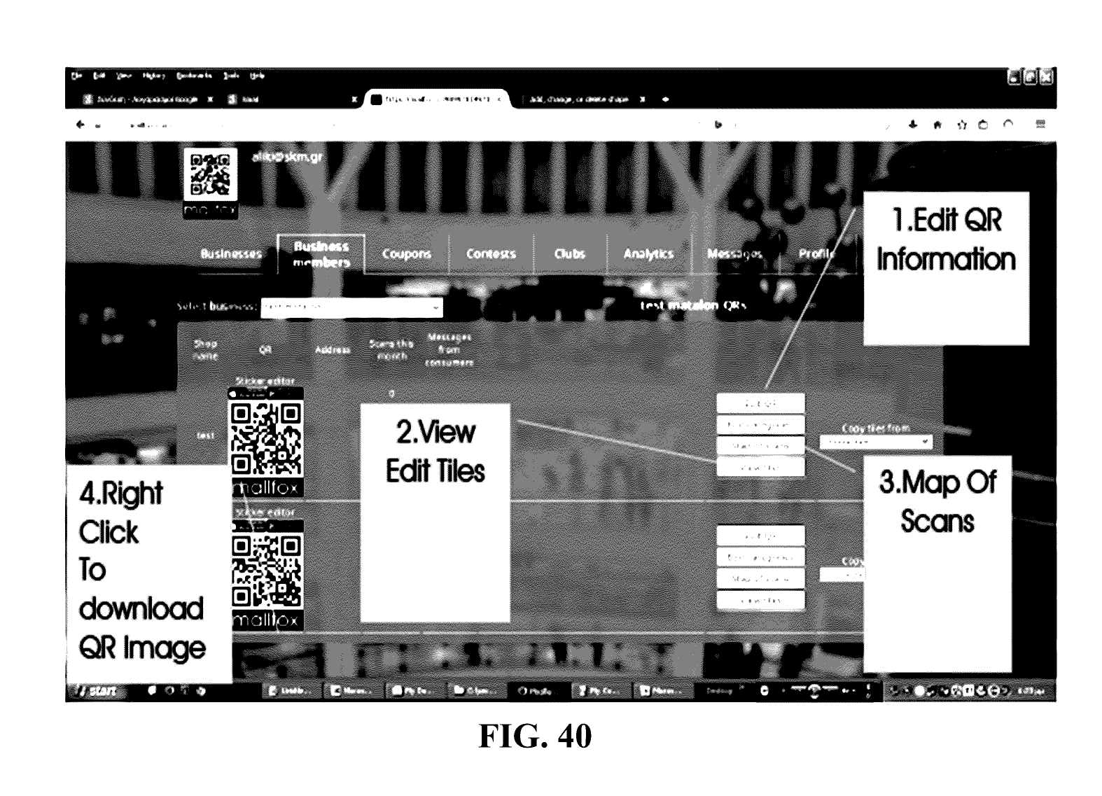

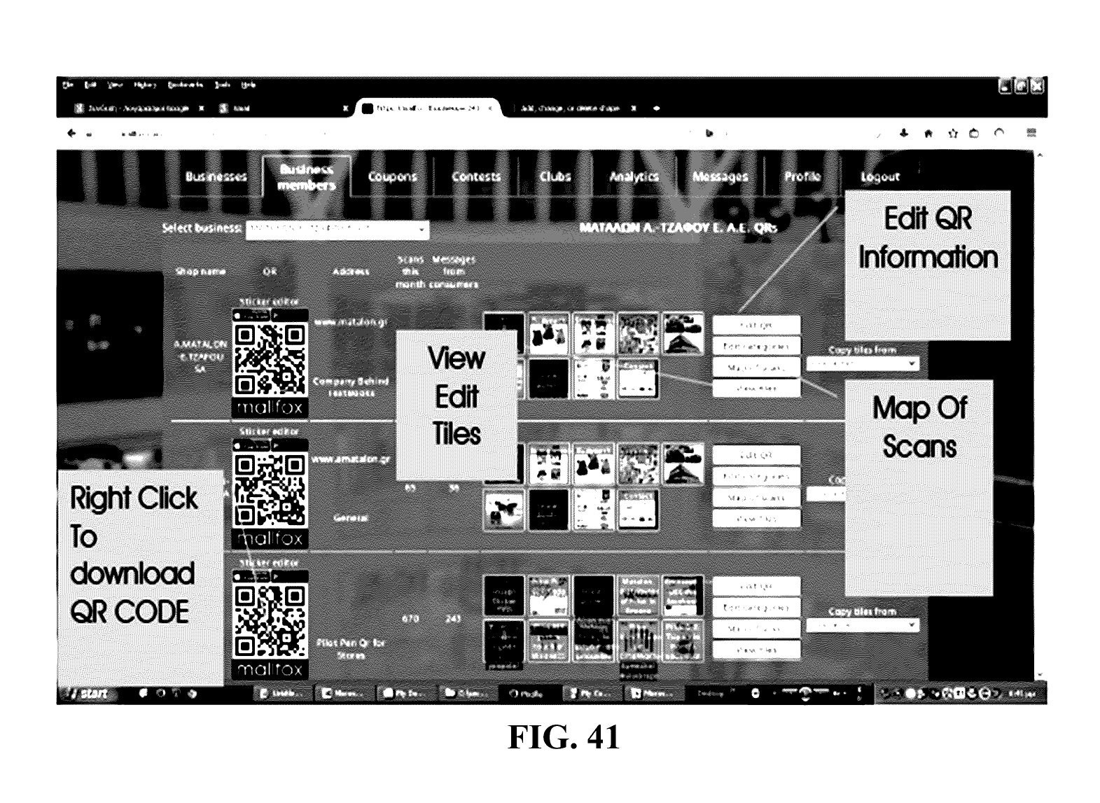

FIGS. 40-41 show the private web page where MALLFOX content creators can access and view the MALLFOX QR codes which have been generated on the platform for a particular business. This page allows access to edit the tileset, edit various QR properties, and view statistics of use of this QR sign.

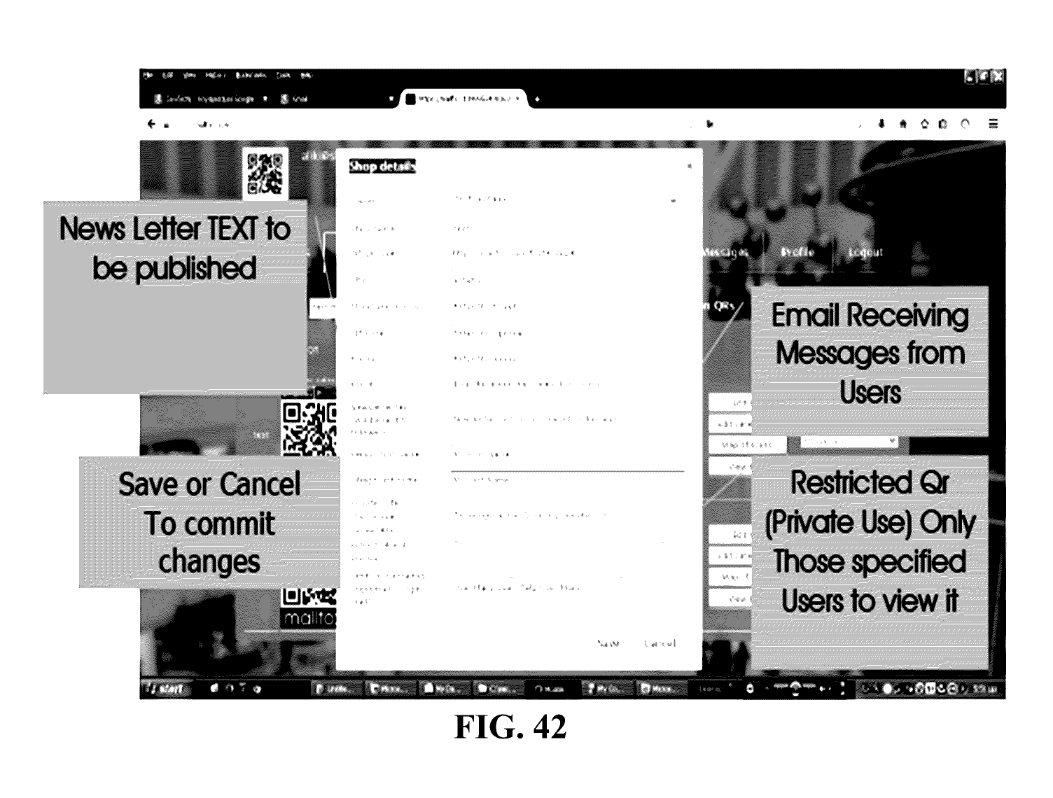

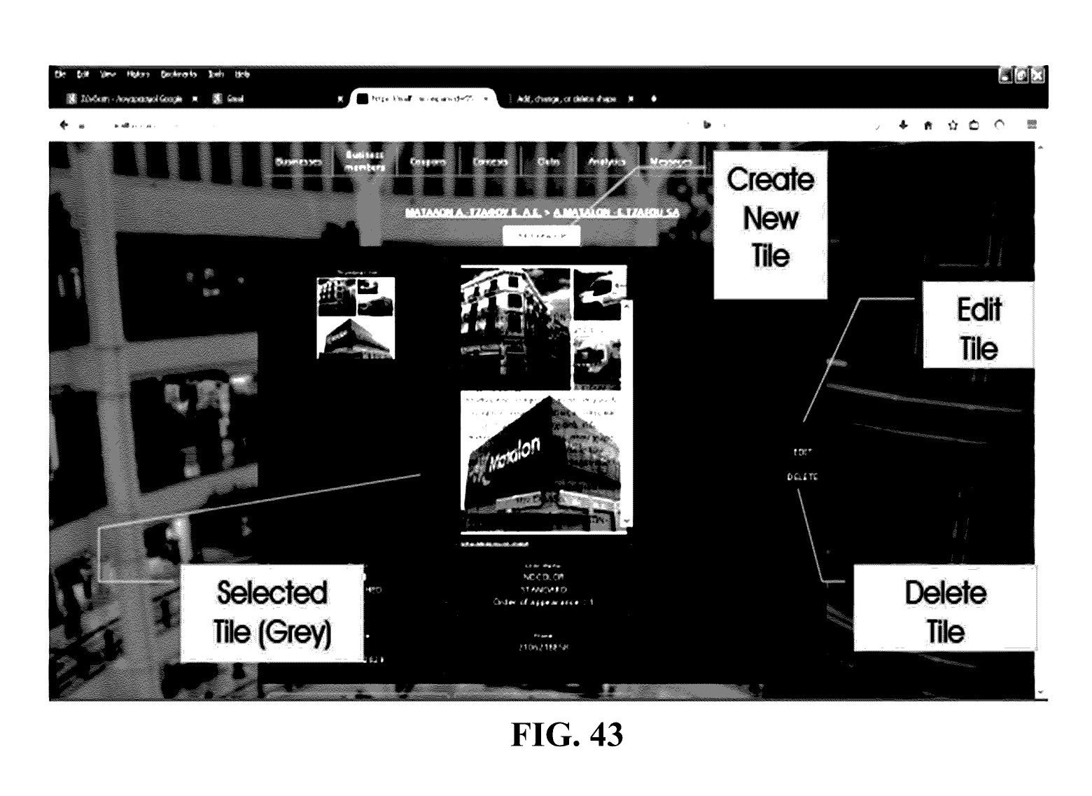

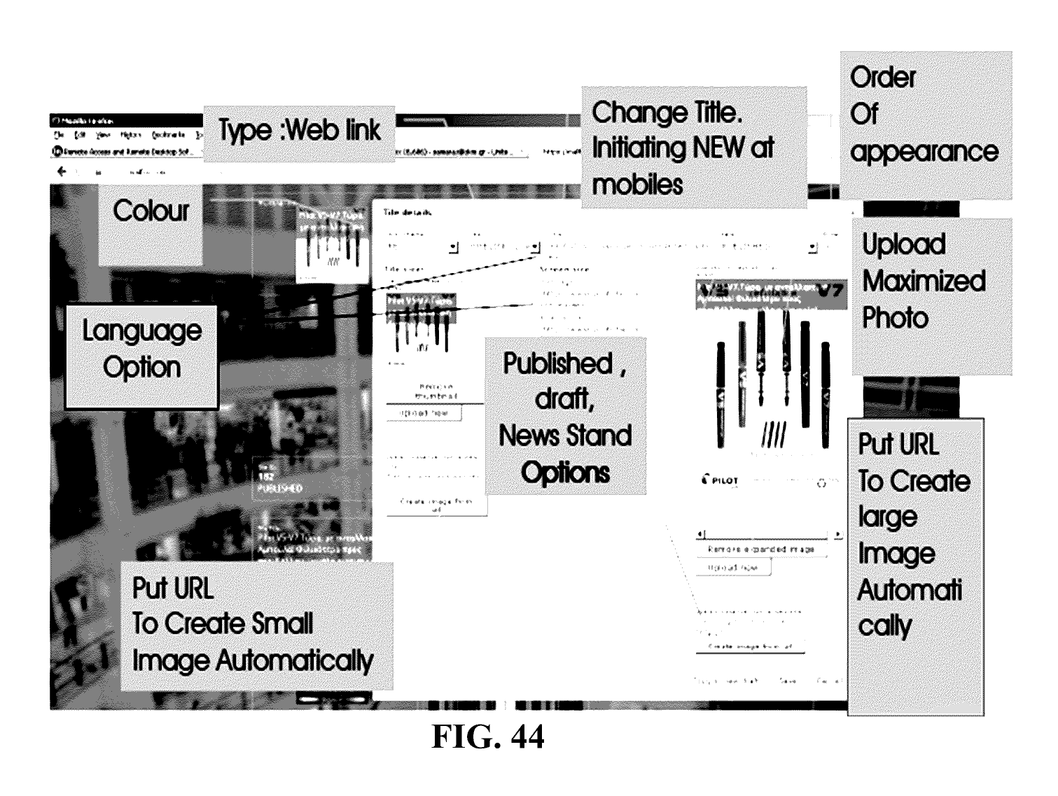

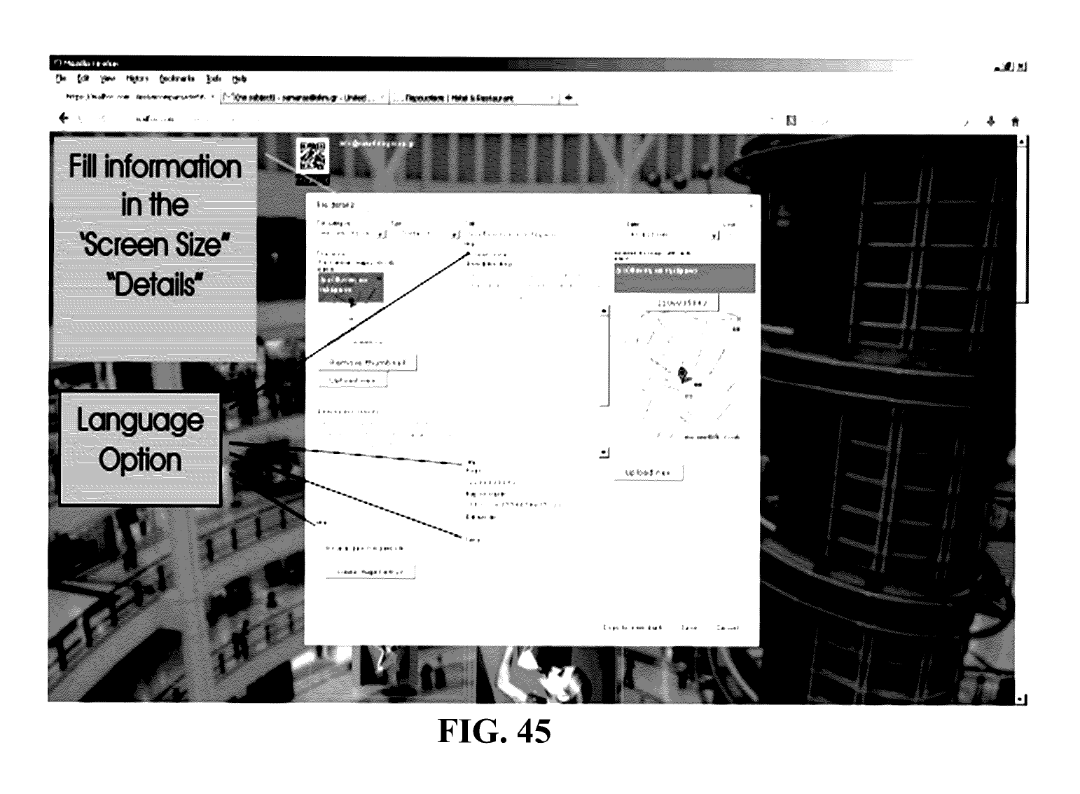

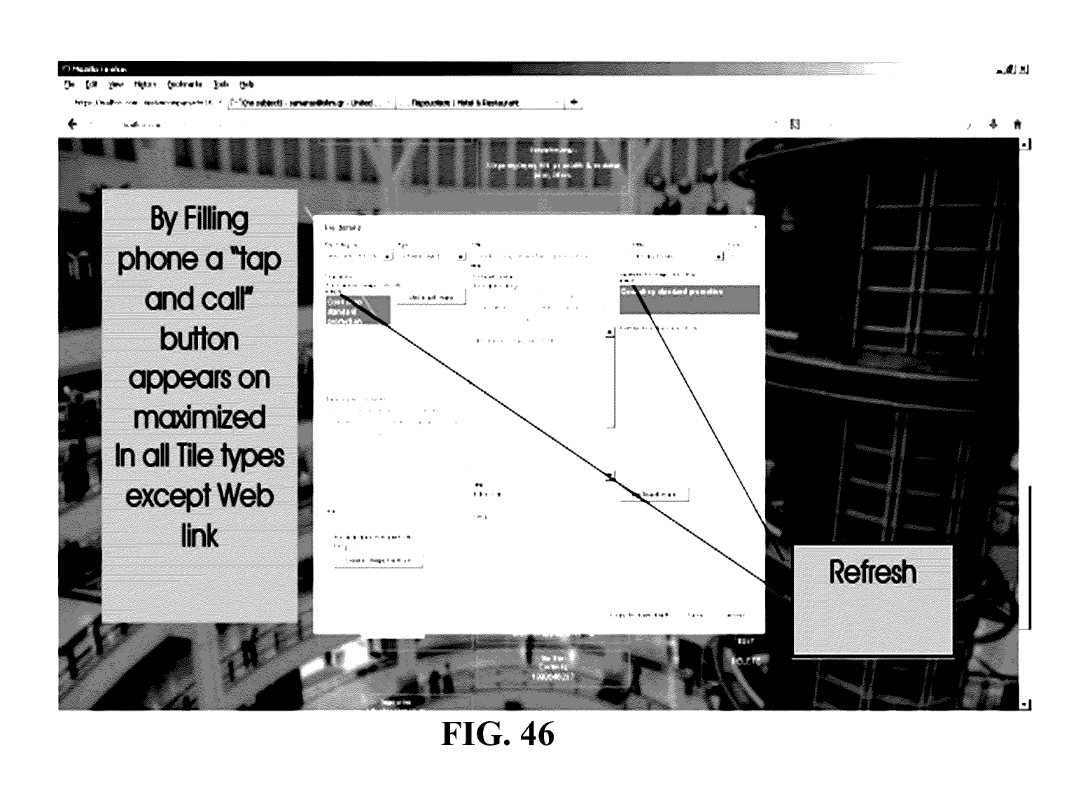

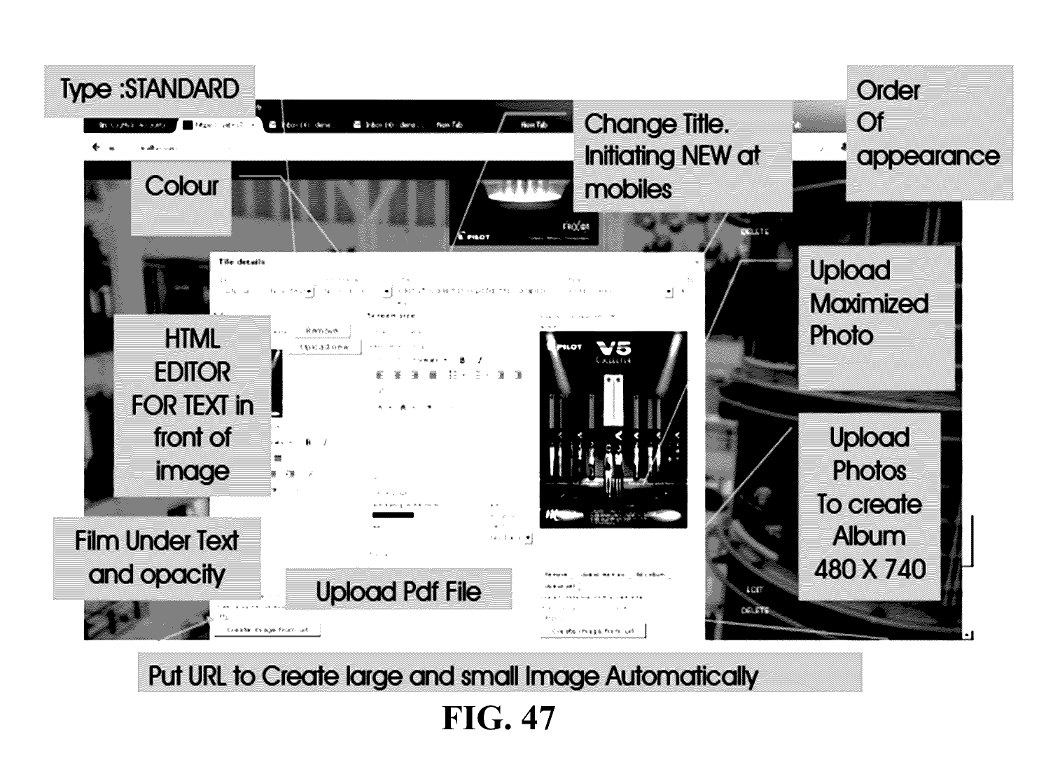

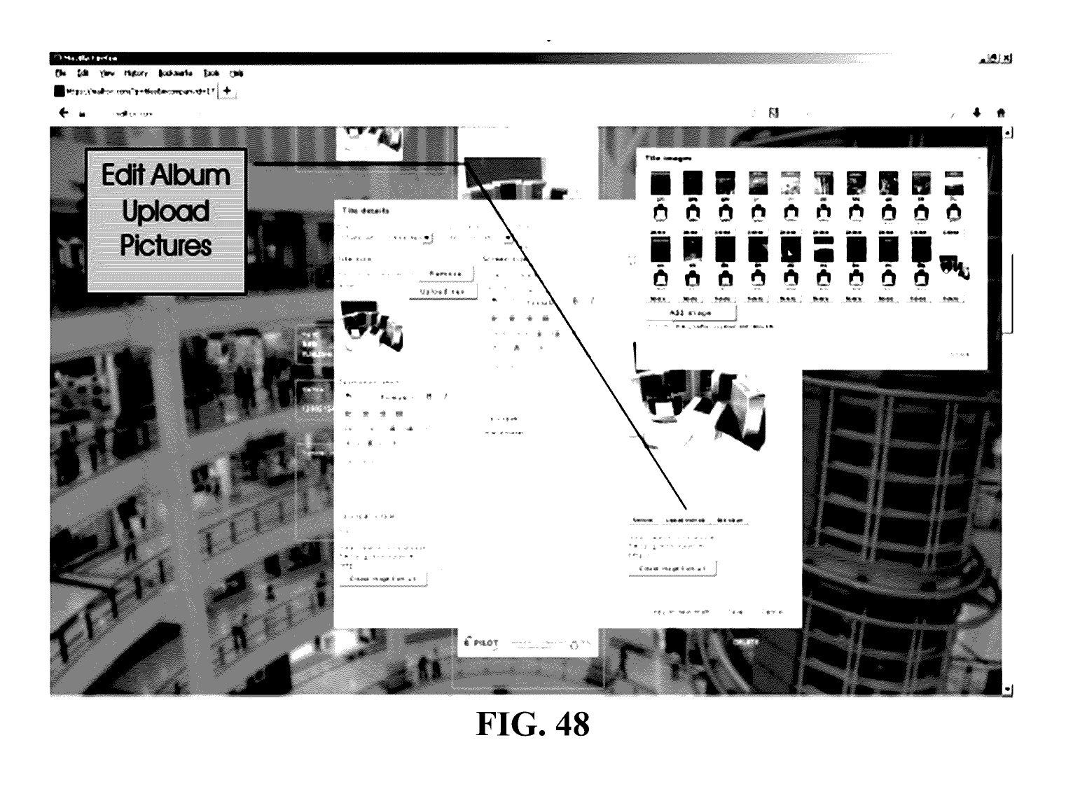

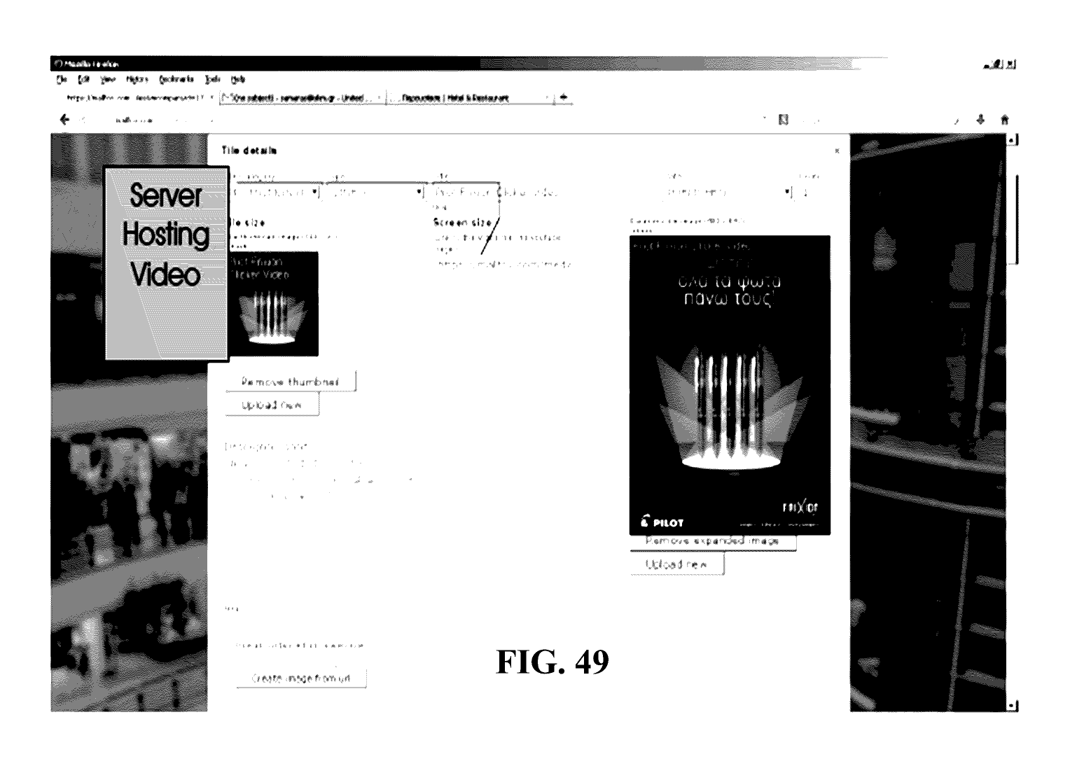

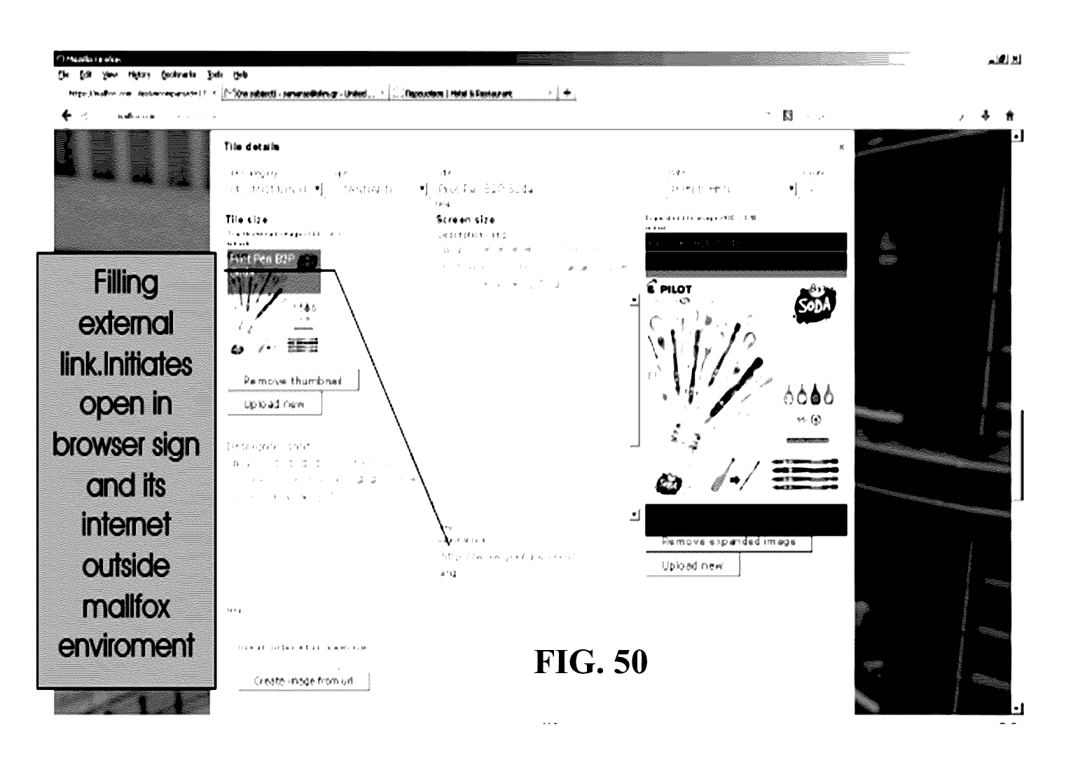

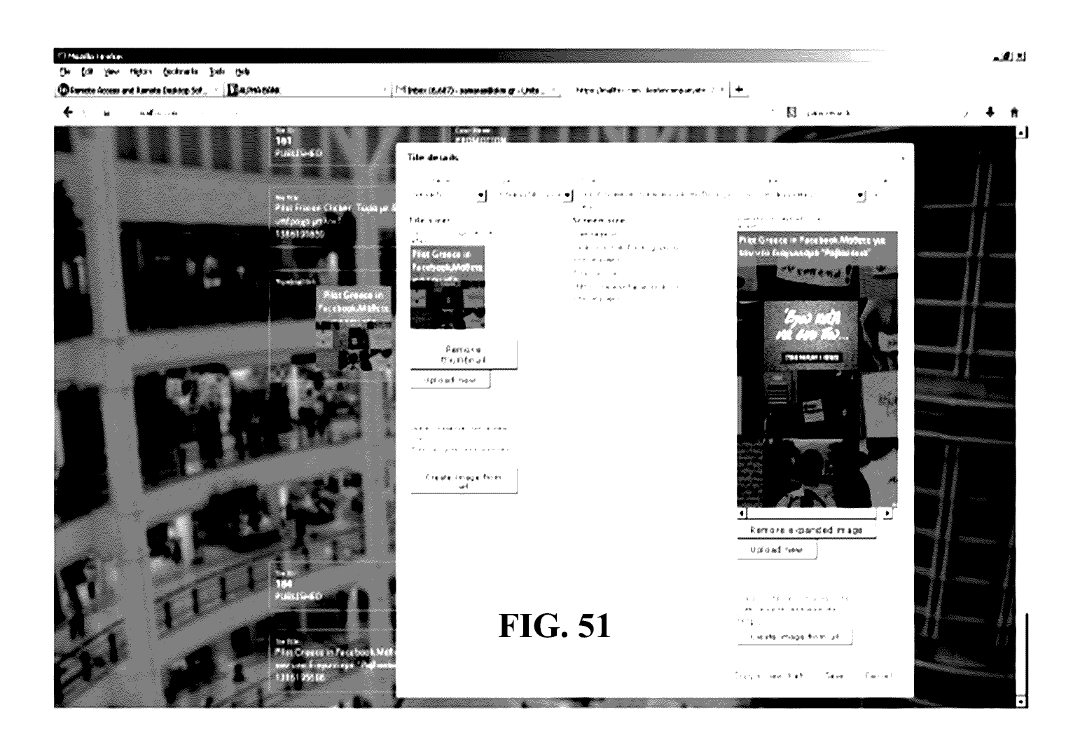

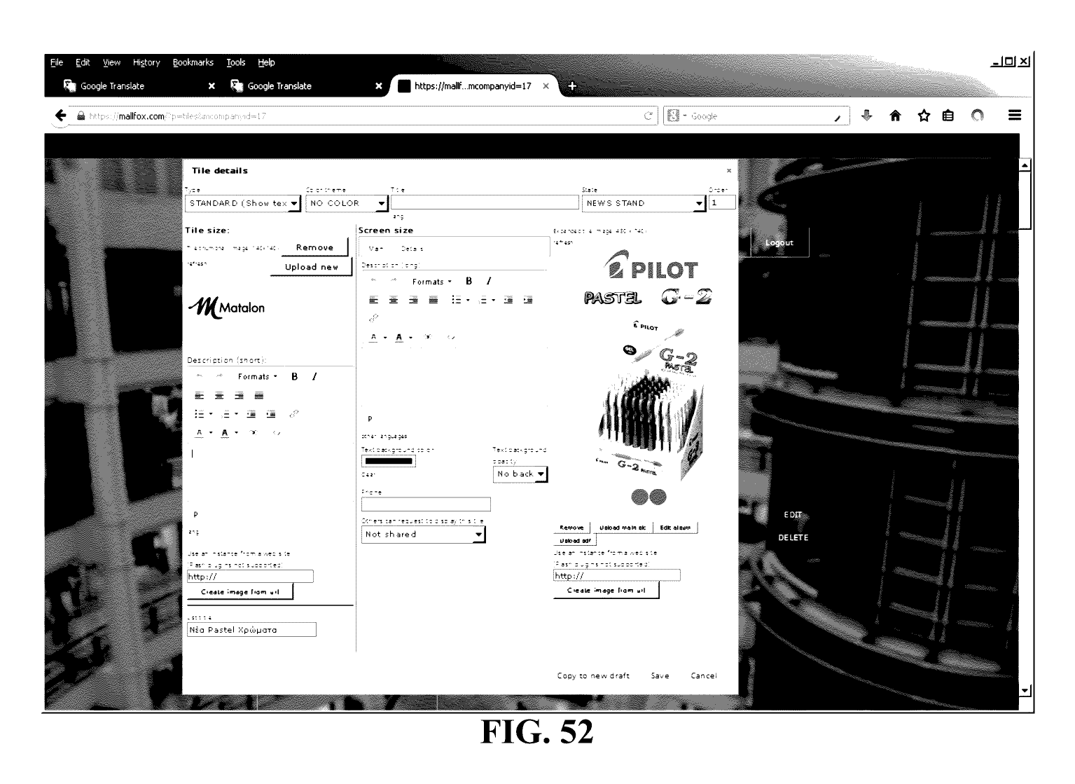

FIGS. 42-52 show the private web pages where MALLFOX content creators can access and edit the properties of a single QR code, as well view and edit the tiles linked to that QR, enabling the customized experience for mobile users.

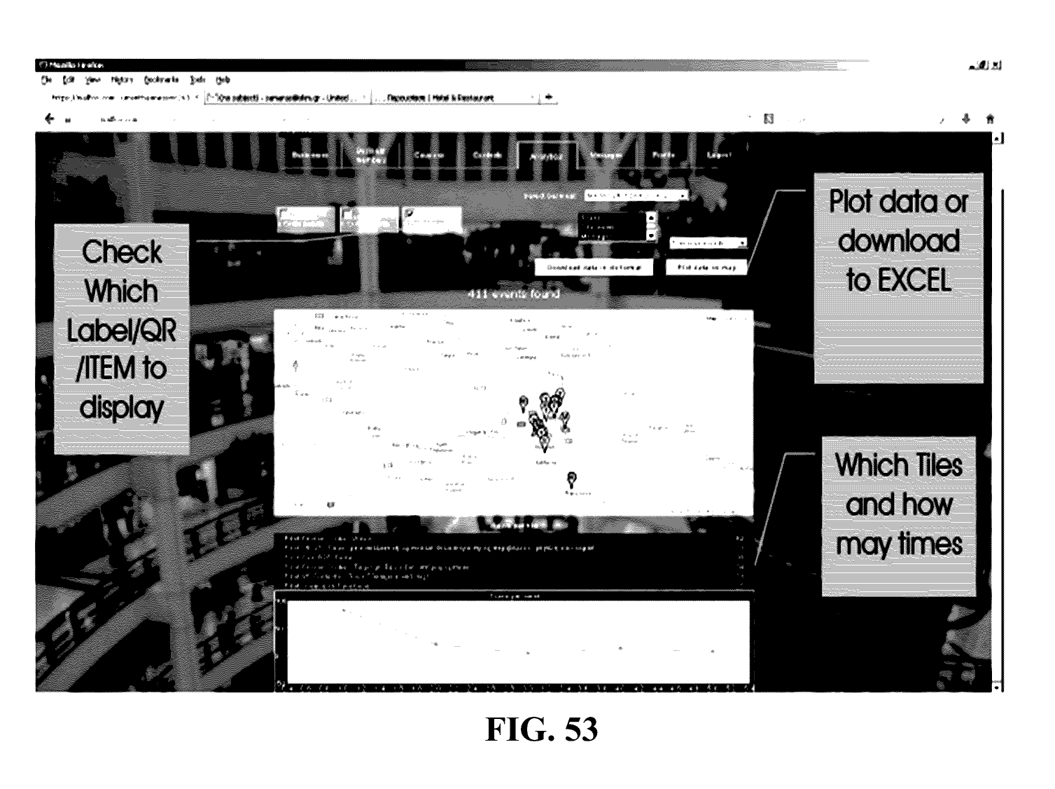

FIG. 53 shows the private web page where MALLFOX content creators can access and view a report on how many mobile users scanned their content and in which locations, with various options to filter and export this information.

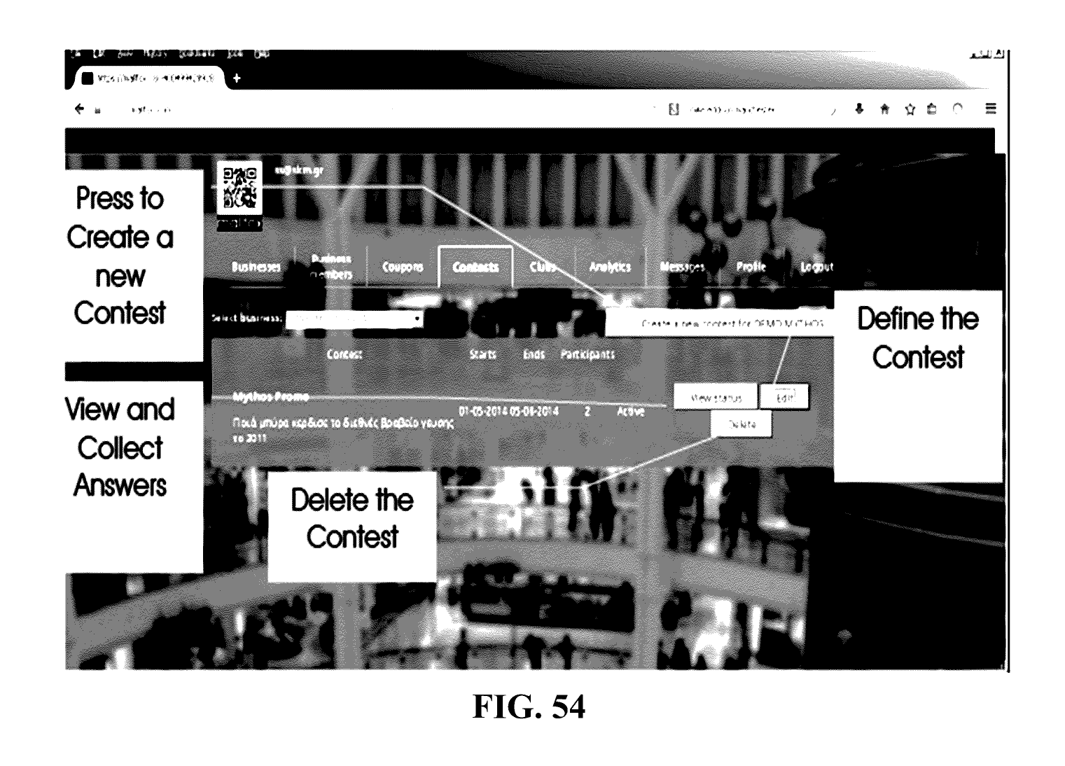

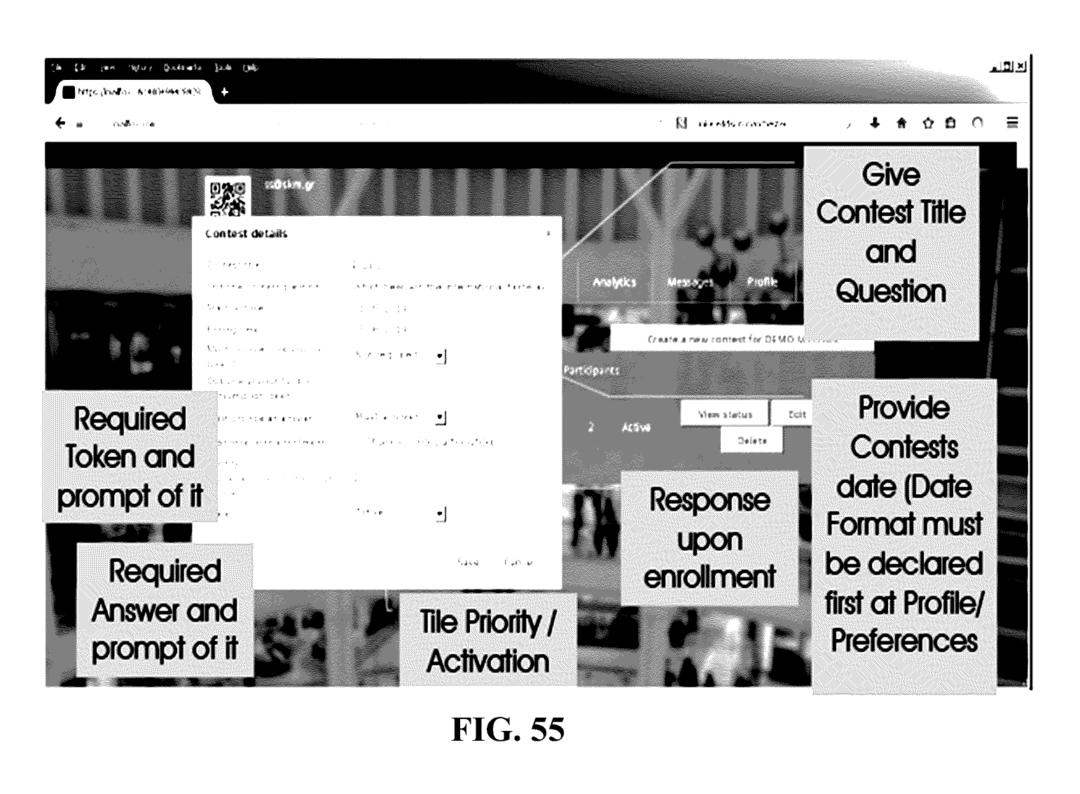

FIGS. 54 and 55 show the private web pages where MALLFOX content creators can access and edit contests linked to special tiles in their tileset.

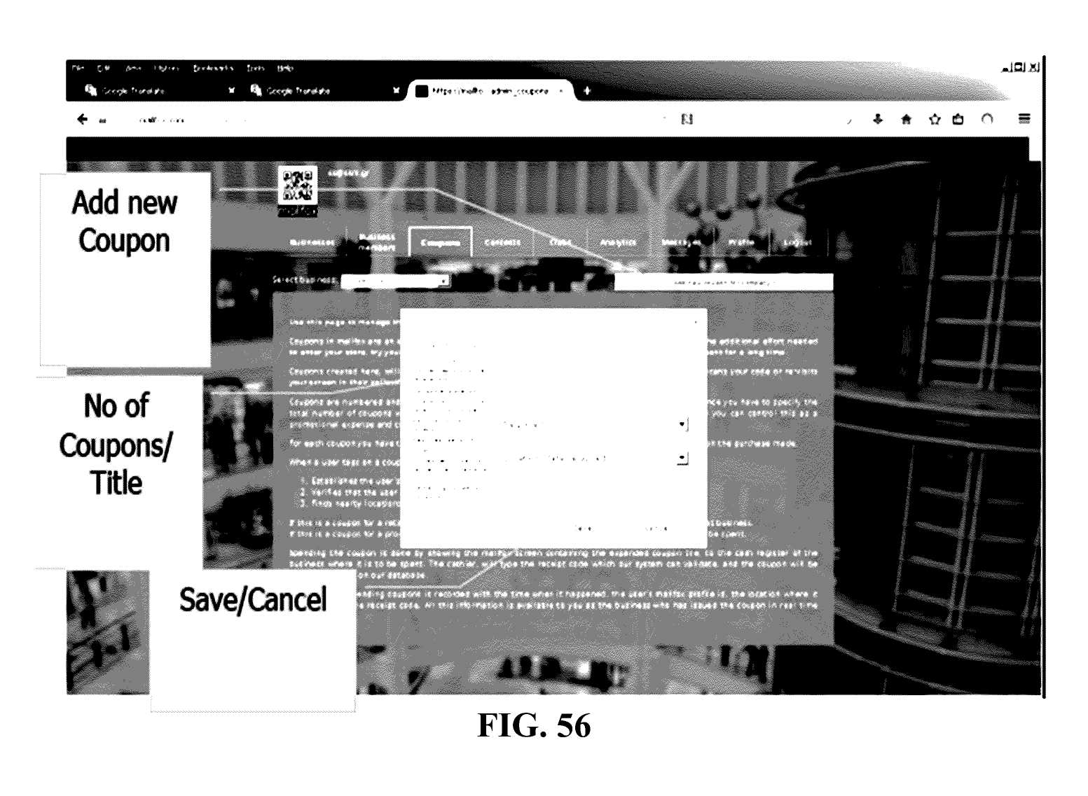

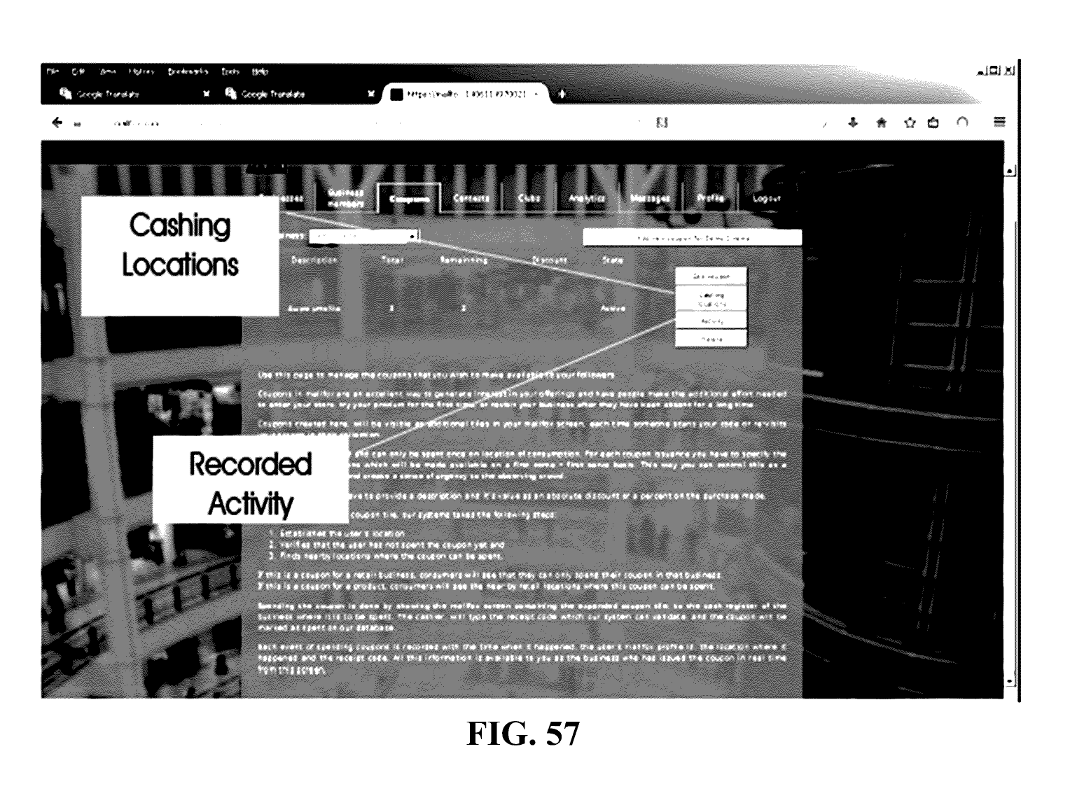

FIGS. 56 and 57 show the private web page where MALLFOX content creators can access and view their issued coupons and issue new ones. A maximum number of coupons can be set, so that publishers can assess the total cost of a promotional action. A specific geographic location can be set for cashing the coupons. A set of consumption codes can be linked to each coupon. A set of specific cashing locations—sales points—can be set. Running coupon campaign data can be accessed from this page, showing how many coupons have been cashed, where and by whom. Each mobile user can cash only one coupon per campaign.

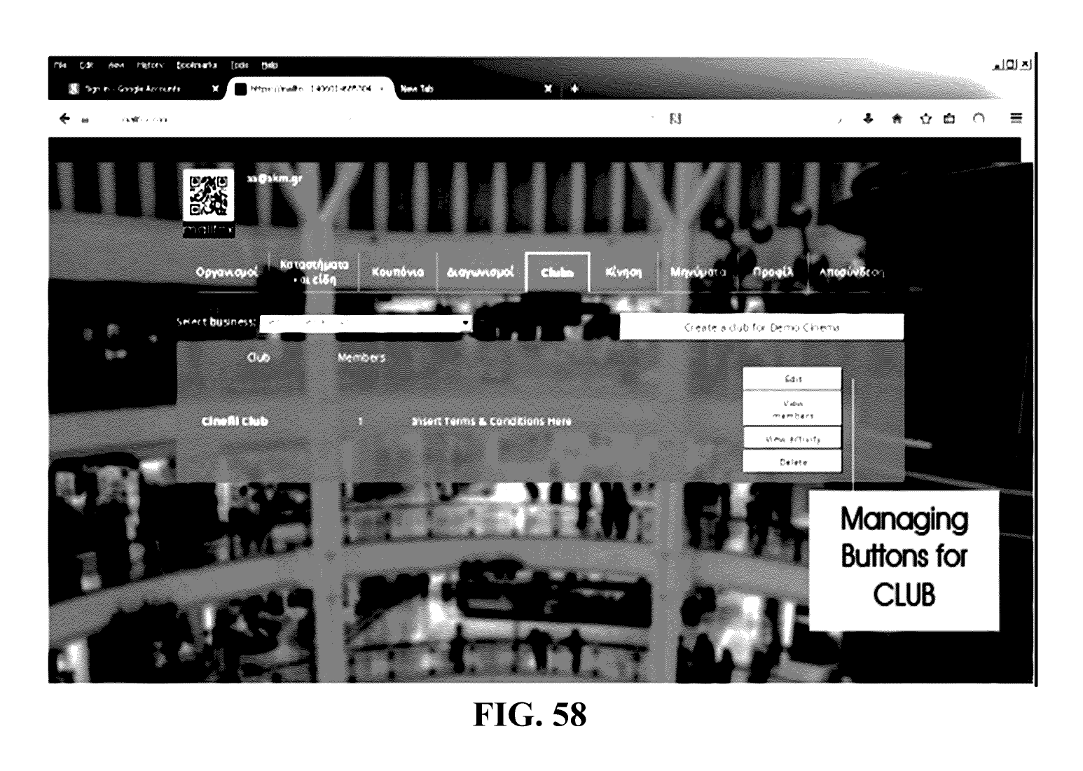

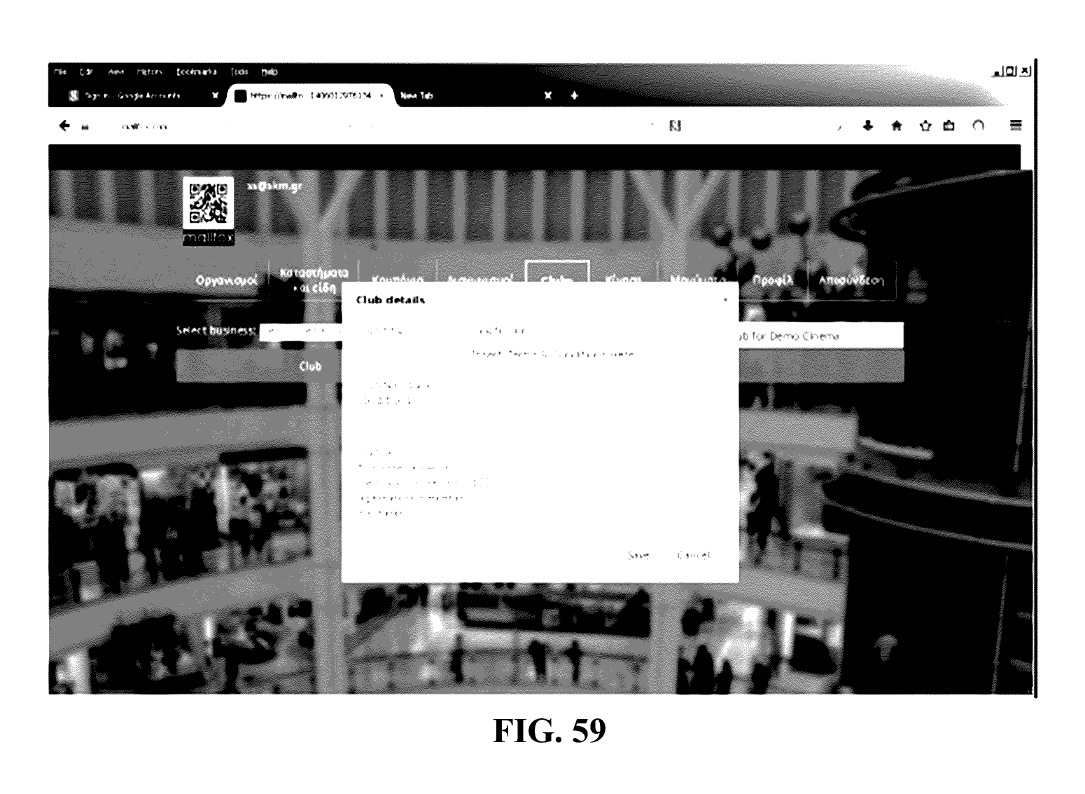

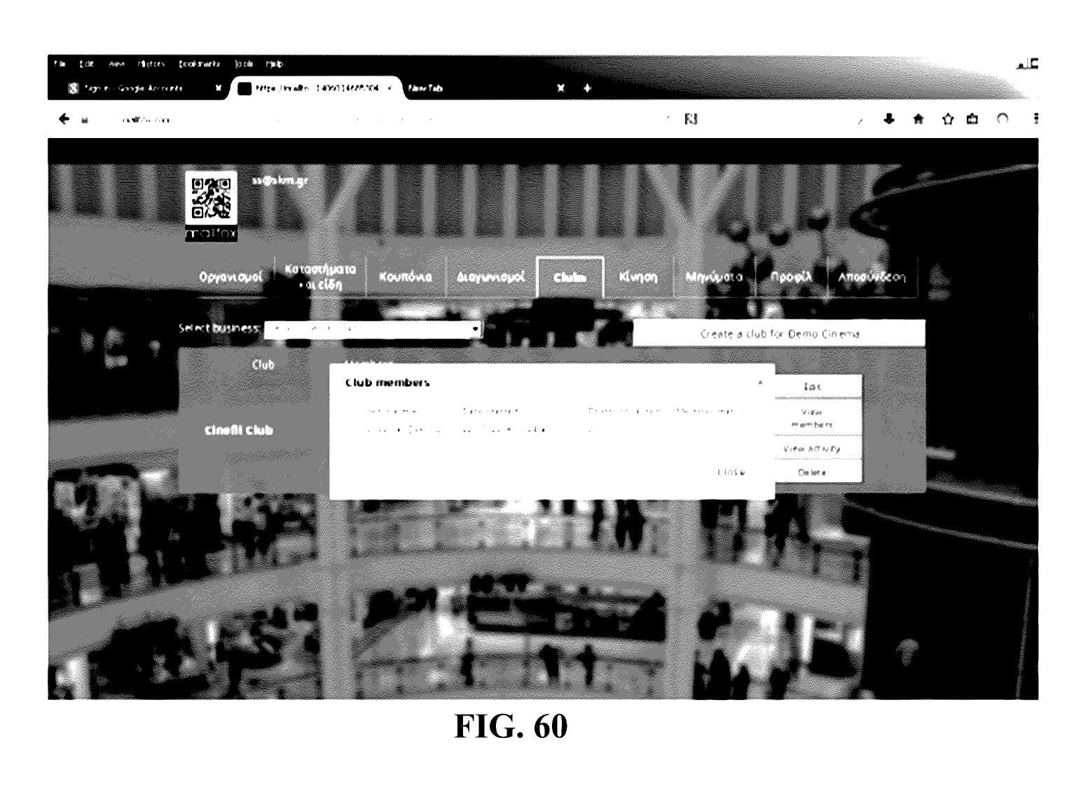

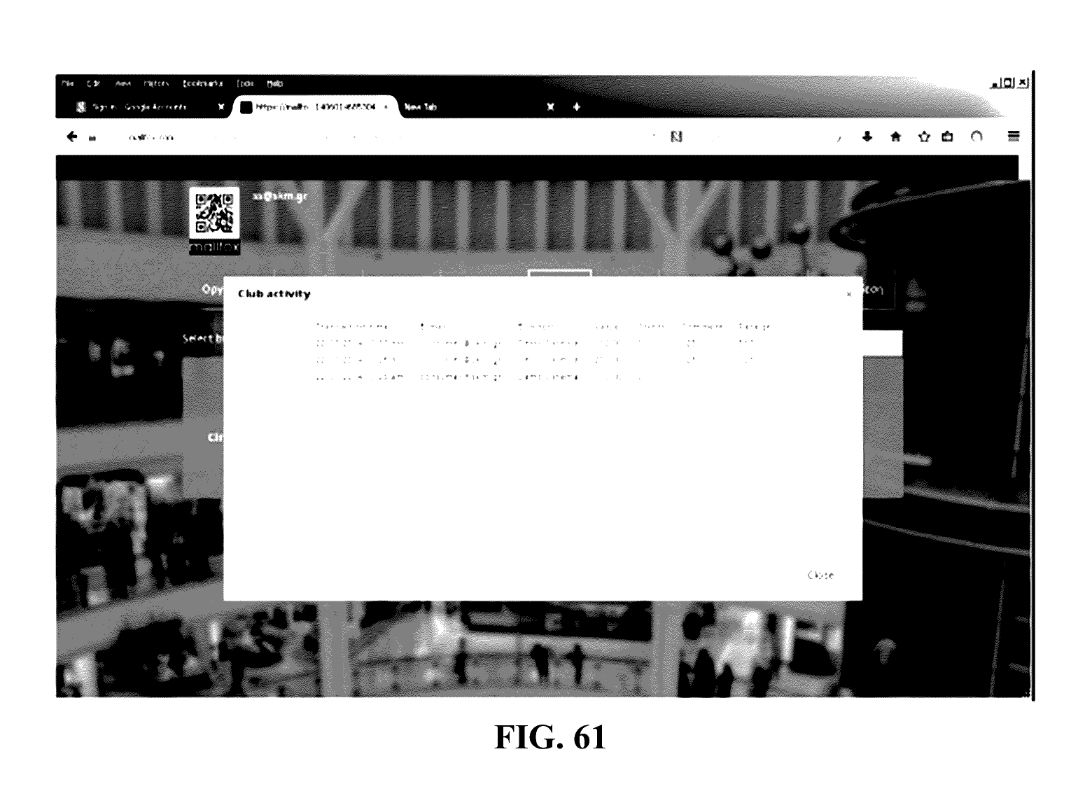

FIGS. 58-61 show the private web page where MALLFOX content creators can access and view their consumer clubs. This page allows content creators to start a club, and view how many members have joined, and what they have consumed.

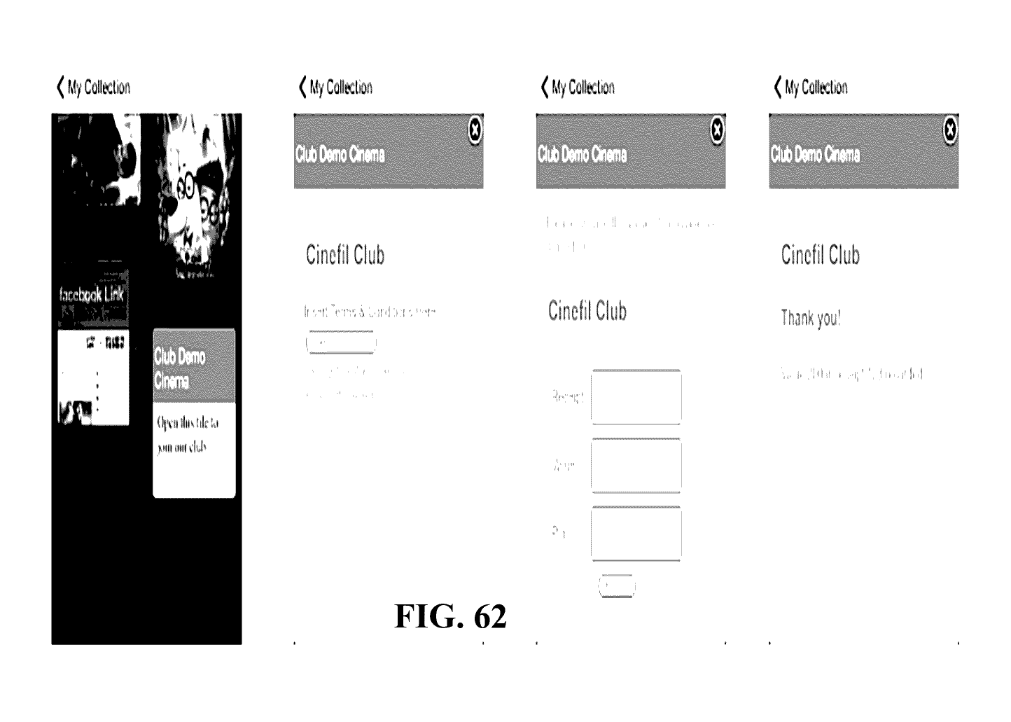

FIG. 62 shows how a consumer club appears inside the MALLFOX mobile app after it has been linked to a QR of a bar-code driven tileset. Mobile users will see a special tile, inviting them to join this club and be shown CLUB specific terms and conditions. After a consumer has opted to join a club, the invitation tile will be replaced by a tile offering to the mobile user an opportunity to earn club points by buying items from the related business.

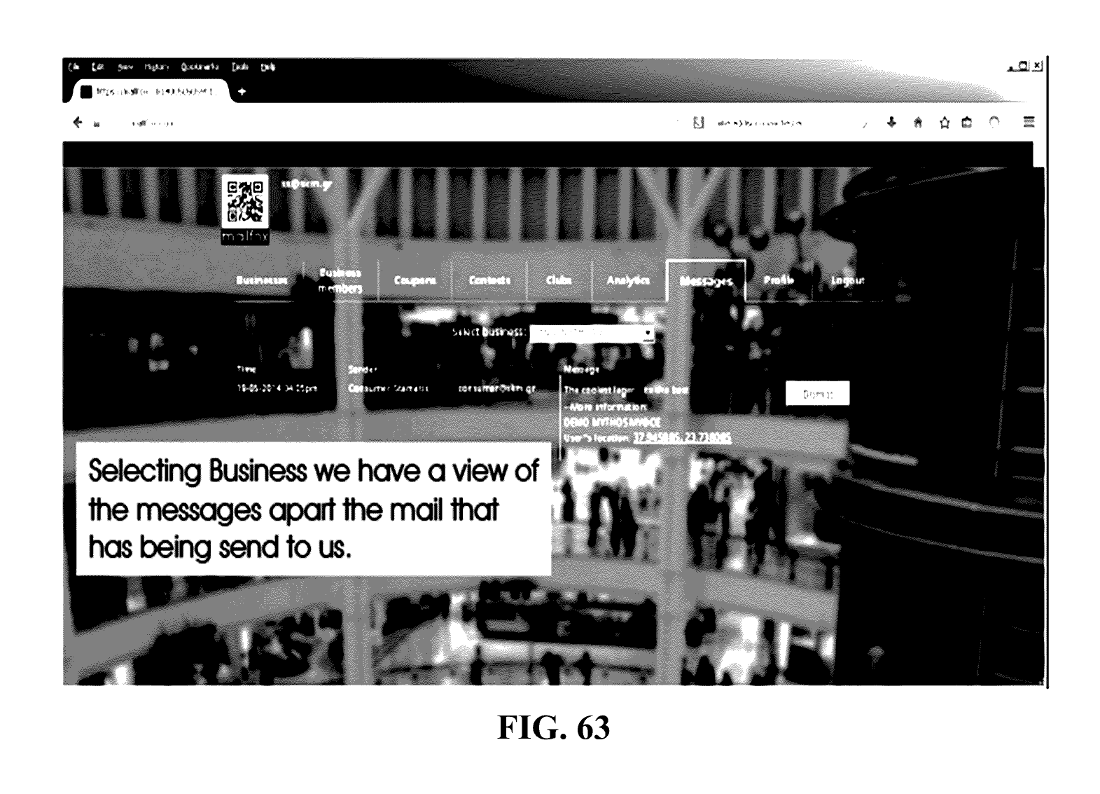

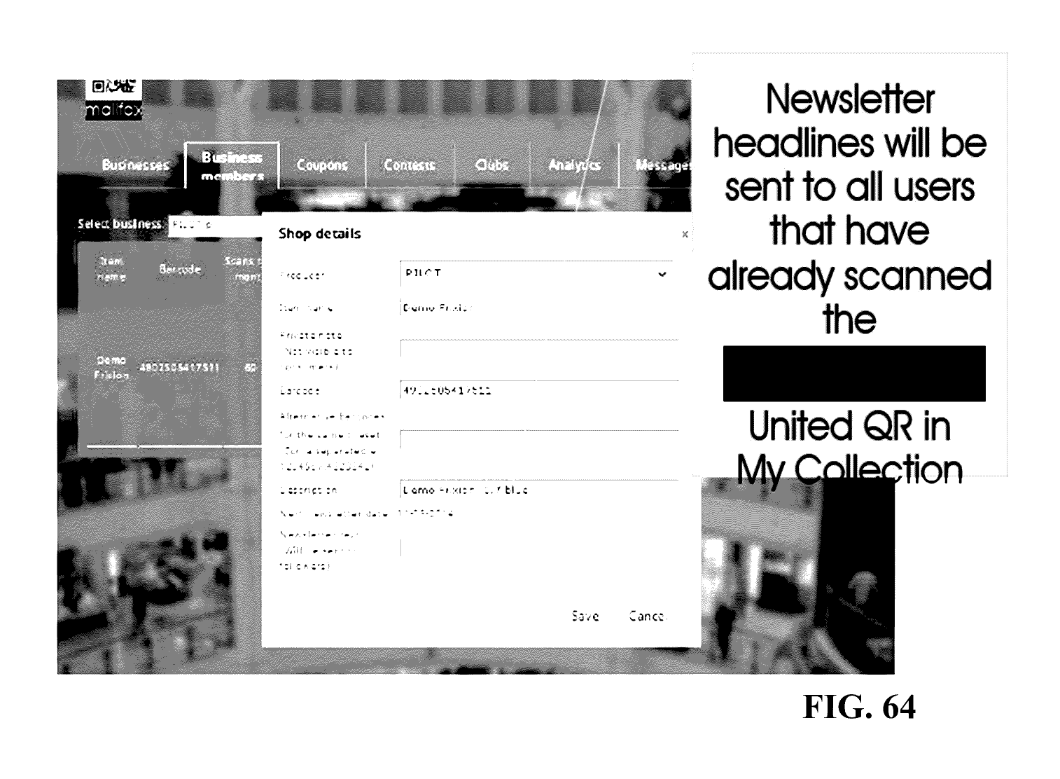

FIGS. 63 and 64 shows the sending of messages and particularly how a business can add a promotional message which will be sent by e-mail to all mobile users who have chosen to keep this business in their collection.

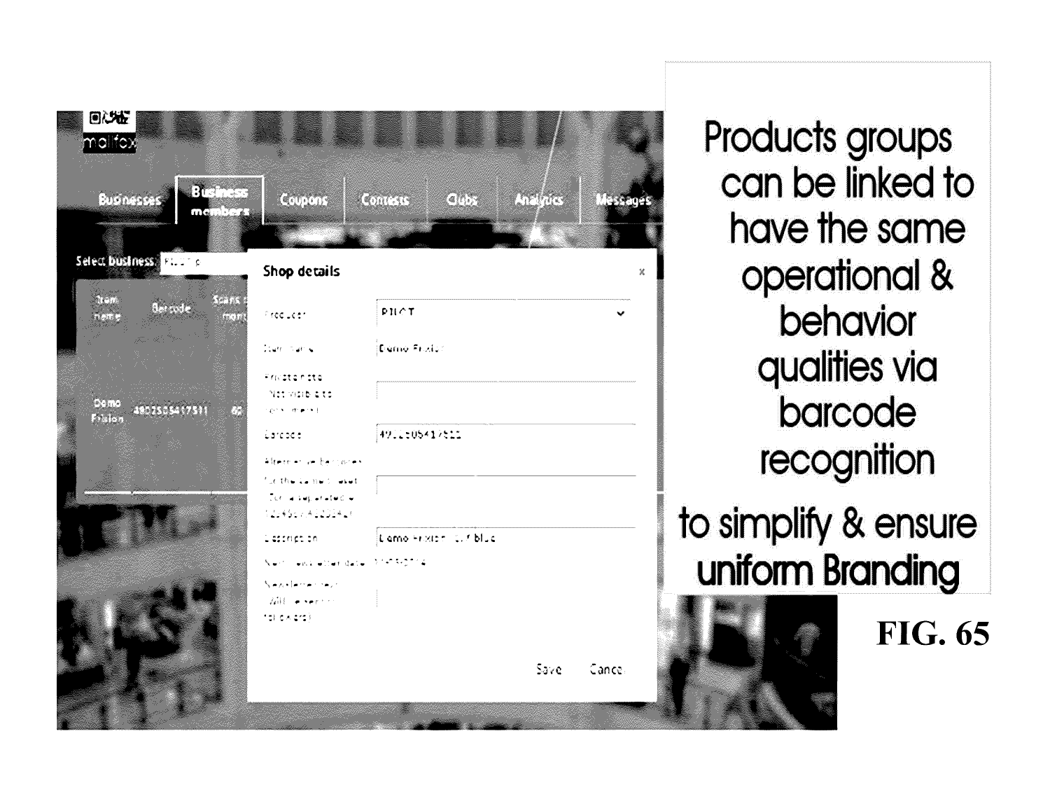

FIG. 65 shows how businesses can use the same exact tileset for a number of different bar code signs, for example all of the bar codes issued to each product in a product category.

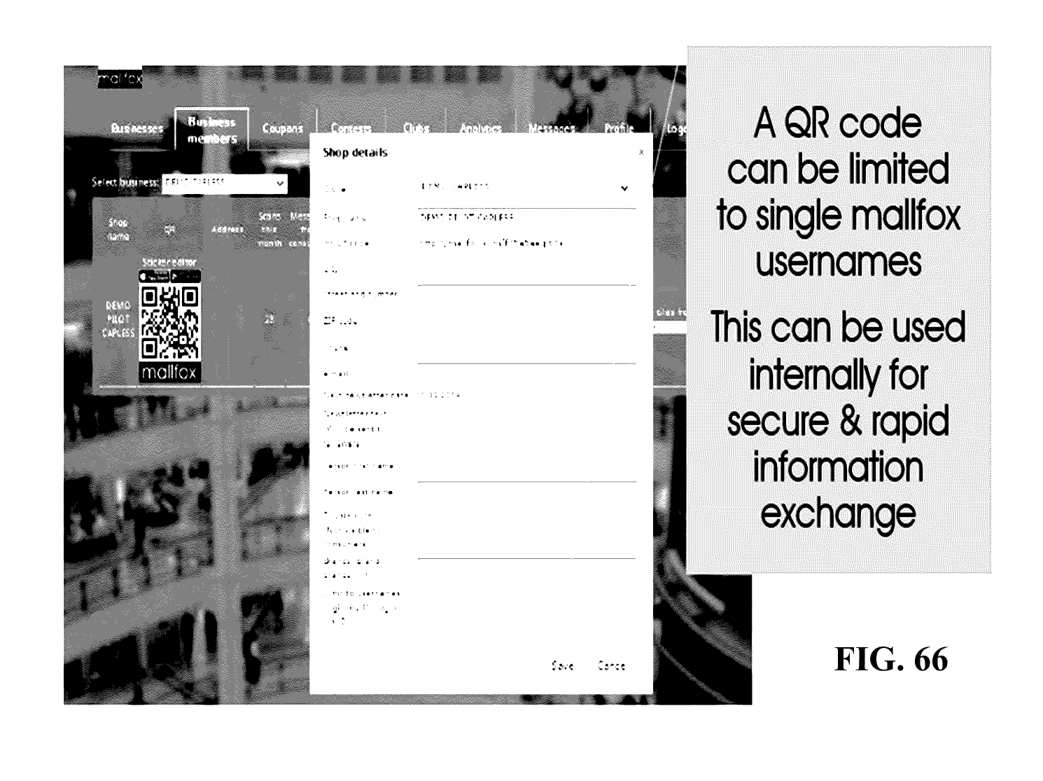

FIG. 66 shows how a business can limit access to a tileset for only registered users in the MALLFOX app, who have specific usernames.

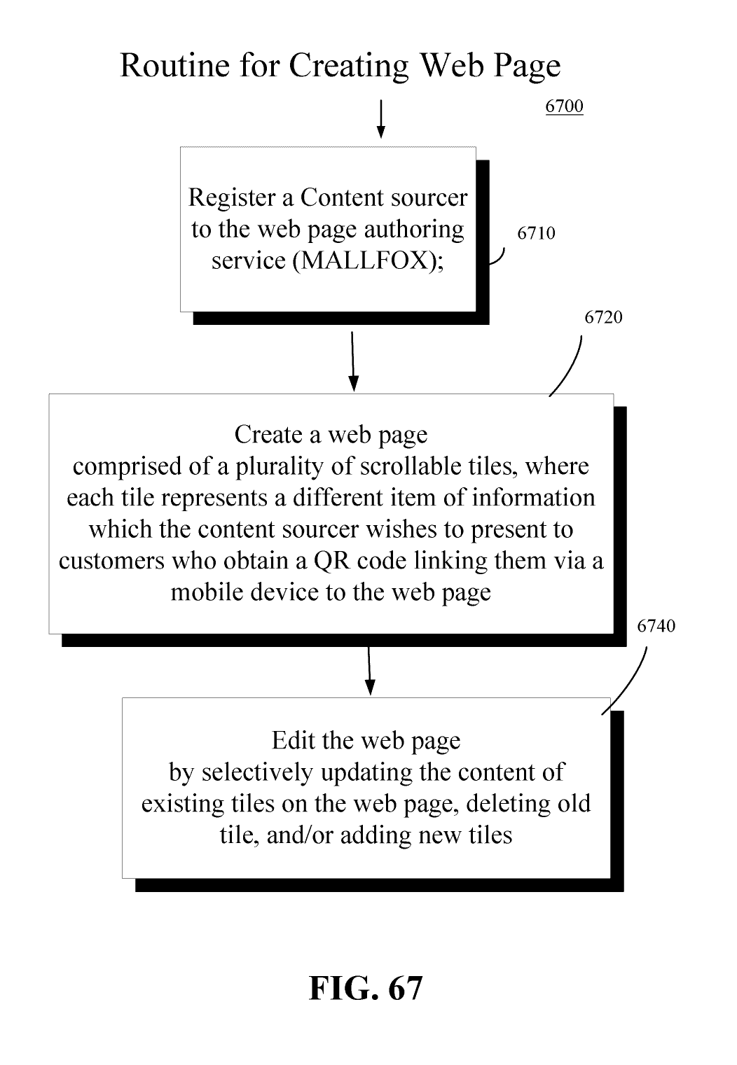

FIG. 67 is a high level operational flow diagram showing the routine 6700 for creating a MALLFOX web page in accordance with an exemplary embodiment.

At step 6710, the content sourcer is registered to the MALLFOX platform and specifically to the web page authoring service (MALLFOX).

At step 6720, the service detects the clients input and creates a web page comprised of a plurality of scrollable tiles, where each tile represents a different item of information which the content sourcer wishes to present to customers who obtain a QR code linking them via a mobile device to the web page.

At step 6740, the service allows for editing the web page by selectively updating the content of existing tiles on the web page, deleting old tilex, and/or adding new tiles

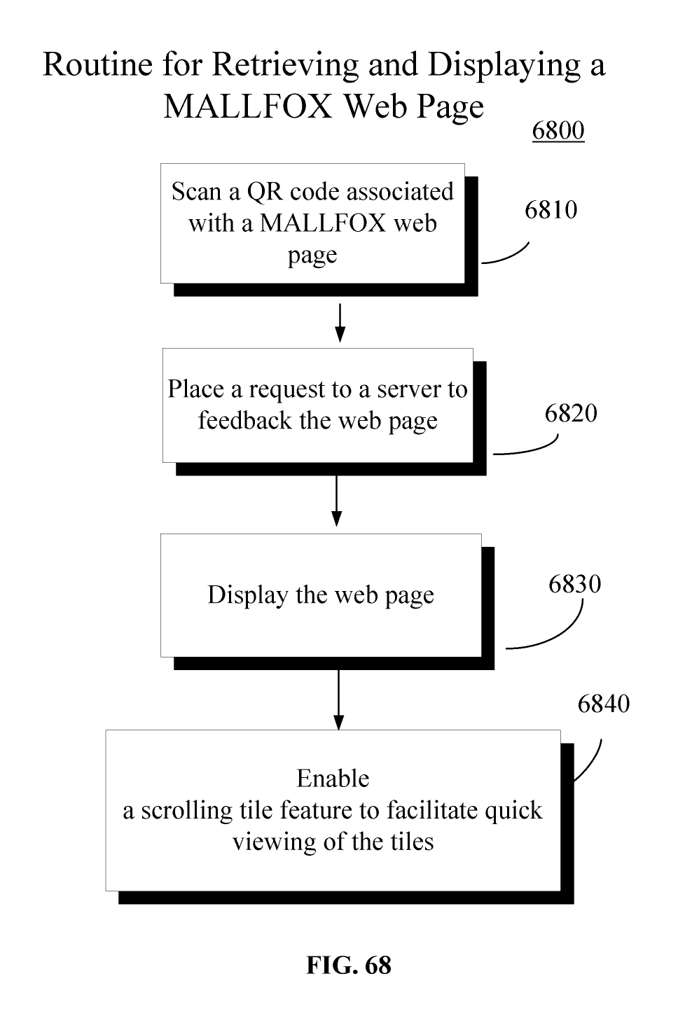

FIG. 68 is a high level operational flow diagram showing the routine 6800 for retrieving and displaying a MALLFOX web page in accordance with an exemplary embodiment. (It is envioned that when a page is accessed from a generic QR scanner and displayed in a browser it will not be personalized, nor will it enable the consumption of coupons, participation in clubs and contests.)

The following steps are performed by the mobile device in order to retrieve and display a MALLFOX server stored web page:

scan a QR code associated with the web page; (step 6810)

place a request to a server to feedback the web page; (step 6820)

display the web page; (step 6830) and

enable a scrolling tile feature to facilitate quick viewing of the tiles. (step 6840)

The embodiments described above are intended to illustrate aspects of the invention and modifications, variants and equivalents such as would be readily apparent to the skilled person are encompassed within the scope of the invention such as defined, for example, by the claims.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An electronic system comprising:
means for registering a content sourcer to a web page authoring service;
means for creating a web page comprised of a plurality of scrollable tiles, where each tile represents a different item of information which the content sourcer wishes to present to customers who obtain a QR code linking them via a mobile device to the web page; and
means for editing the web page by selectively updating the content of existing tiles on the web page, deleting old tile, and/or adding new tiles.

2. The electronic system of claim 1, further comprising means for assigning a QR code to the web page, which QR code is the QR code linking the customers via a mobile device to the web page.

3. The electronic system of claim 1, further comprising means for assigning a QR code to the web page, which QR code is the QR code linking the customers via a mobile device to the web page, and which QR code was provided by the content sourcer.

4. In an electronic system a method comprising:
registering a content sourcer to a web page authoring service;
creating a web page comprised of a plurality of scrollable tiles, where each tile represents a different item of information which the content sourcer wishes to present to customers who obtain a QR code linking them via a mobile device to the web page; and
editing the web page by selectively updating the content of existing tiles on the web page, deleting old tile, and/or adding new tiles.

5. The method of claim 4, further comprising assigning a QR code to the web page, which QR code is the QR code linking the customers via a mobile device to the web page.

6. The method of claim 4, further comprising assigning a QR code to the web page, which QR code is the QR code linking the customers via a mobile device to the web page, and which QR code was provided by the content sourcer.

7. A computer program product including a non-transient computer readable media having instructions for causing a computer to:
register a content sourcer to a web page authoring service;
create a web page comprised of a plurality of scrollable tiles, where each tile represents a different item of information which the content sourcer wishes to present to customers who obtain a QR code linking them via a mobile device to the web page; and
edit the web page by selectively updating the content of existing tiles on the web page, deleting old tile, and/or adding new tiles.

8. The computer program product of claim 7, further comprising an instruction to assign a QR code to the web page, which QR code is the QR code linking the customers via a mobile device to the web page.

9. The computer program product of claim 7, further comprising an instruction to assign a QR code to the web page, which QR code is the QR code linking the customers via a mobile device to the web page. and which QR code was provided by the content sourcer.

10. In a mobile device, a method of retrieving and displaying a web page defined by a set of scrollable tiles, which scrollable tiles are of the type generated by a content sourcer using a software product configured as a web page authoring tool with specific rules to facilitate the tile creation, the method comprising:
scanning a QR code associated with the web page;
placing a request to a server to feedback the web page;
displaying the web page; and
enabling a scrolling tile feature to facilitate quick viewing of the tiles.

11. The method of claim 10, further comprising accessing at least one of user identity, location and language preferences prior to placing the request to the server.

12. A mobile device configured to retrieve and display a web page defined by a set of scrollable tiles, which scrollable tiles are of the type generated by a content sourcer using a software product configured as a web page authoring tool with specific rules to facilitate the tile creation, comprising:
means for scanning a QR code associated with the web page;
means for placing a request to a server to feedback the web page;
means for displaying the web page; and
means for enabling a scrolling tile feature to facilitate quick viewing of the tiles.

13. The mobile device of claim 12, further comprising means for accessing at least one of user identity, location and language preferences prior to placing the request to the server.

14. A computer program product including a non-transient computer readable media having instructions for causing a mobile device to retrieve and display a web page defined by a set of scrollable tiles, which scrollable tiles are of the type generated by a content sourcer using a software product configured as a web page authoring tool with specific rules to facilitate the tile creation, the instructions including instructions to:
scan a QR code associated with the web page;
place a request to a server to feedback the web page;
display the web page; and
enable a scrolling tile feature to facilitate quick viewing of the tiles.

15. The computer program product of claim 14, further comprising an instruction to access at least one of user identity, location and language preferences prior to placing the request to the server.
